(19) United States
(12) Patent Application Publication
(10) Pub. No.: US 2024/0280919 A1
(43) Pub. Date: Aug. 22, 2024

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Masahiro IWASAKI, Kanagawa (JP); Masaki HIRAKARA, kanagawa (JP); Hideya KATSUHARA, Kanagawa (JP); Kenta IDE, Kanagawa (JP)

(73) Assignee: FUJIFILM Business Innovation Corp., Tokyo (JP)

(21) Appl. No.: 18/366,315

(22) Filed: Aug. 7, 2023

(30) Foreign Application Priority Data
Feb. 2, 2023 (JP) 2023-014866

(51) Int. Cl. G03G 5/147; C08F 120/16; C08F 120/28; C08F 126/06

(52) U.S. Cl. CPC G03G 5/14734; C08F 120/16; C08F 120/28; C08F 126/06; C08F 2800/20

(57) ABSTRACT

An electrophotographic photoreceptor includes a conductive substrate, a charge generation layer provided on the conductive substrate, a charge transport layer provided on the charge generation layer, and a surface protective layer provided on the charge transport layer, in which the surface protective layer is a cured film formed of a composition that contains a resin (X) having at least one of a unit represented by Formula (X1) or a unit represented by Formula (X2) and a reactive group-containing charge transport material containing a reactive group and a charge-transporting skeleton in an identical molecule.

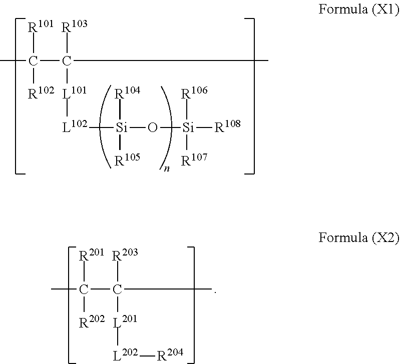

### CROSS-REFERENCE TO RELATED APPLICATIONS

This application is based on and claims priority under 35 USC 119 from Japanese Patent Application No. 2023-014866 filed Feb. 2, 2023.

### BACKGROUND

### (i) Technical Field

The present invention relates to an electrophotographic photoreceptor, a process cartridge, and an image forming apparatus.

### (ii) Related Art

JP2003-043721A describes “an electrophotographic photoreceptor used in an electrophotographic device including an electrophotographic photoreceptor, a charging unit that charges a surface of the electrophotographic photoreceptor, an information writing unit that forms an electrostatic latent image on the charged electrophotographic photoreceptor, a developing unit that supplies a developer to the electrostatic latent image to visualize the electrostatic latent image, a transfer unit that transfers the visualized developer image to a transfer material, a developer charge amount control unit that is positioned upstream of the charging unit and charges the developer on the electrophotographic photoreceptor, and a residual developer image uniformizing unit that is positioned upstream of the developer charge amount control unit and downstream of the charge unit and uniformizes the residual developer image remaining on the electrophotographic photoreceptor after the developer image is transferred to a transfer material, in which the residual developer image remaining on the electrophotographic photoreceptor after the transfer of the developer image is uniformized by the residual developer image uniformizing unit, the uniformized residual developer on the electrophotographic photoreceptor is subjected to a charging treatment to a normal polarity by the developer charge amount control unit, and the surface of the electrophotographic photoreceptor is charged by the charging unit to have an appropriate charge amount, the electrophotographic photoreceptor includes at least a photosensitive layer and a surface protective layer on a conductive support, and the surface protective layer contains a thermosetting urethane resin”.

JP2003-186224A discloses “an electrophotographic photoreceptor formed by laminating a photosensitive layer and a surface protective layer in this order on an aluminum substrate, in which the surface protective layer contains a curable phenol resin, and the surface of the aluminum substrate on the photosensitive layer side contains aluminum, an oxygen atom, and titanium, or aluminum, an oxygen atom, and zirconium”.

JP2003-244830A discloses “an electrophotographic photoreceptor including a photosensitive layer and a surface protective layer in this order on a cylindrical support, in which the cylindrical support has an outer diameter of less than 30 mm, a difference (|α₁−α₂|) between a thermal expansion coefficient (α₁) measured from the surface protective layer and a thermal expansion coefficient (α₂) measured after removal of the surface protective layer is greater than 5.0×10⁻⁷ [° C.⁻¹] and less than 1.0×10⁻⁴ [° C.⁻¹], and an elastic deformation rate (We %) measured from the surface protective layer is greater than 30 [%] and less than 60 [%].

JP2010-107696A discloses “an image forming apparatus including an electrophotographic photoreceptor that includes at least a photosensitive layer and a surface layer obtained by curing a coating solution on a conductive support, and a unit that supplies a lubricant onto the surface of the electrophotographic photoreceptor, in which the surface layer has a surface provided with a plurality of recesses having a crater shape, and particles of reactive silicone oil modified with a methacryloyloxy group are dispersed in the layer”.

### SUMMARY

An electrophotographic photoreceptor of the related art has a tendency to have streak-like image defects caused by coating film defects occurring in the process of production of a surface protective layer.

Aspects of non-limiting embodiments of the present disclosure relate to an electrophotographic photoreceptor that includes a conductive substrate, a charge generation layer, a charge transport layer, and a surface protective layer in this order, in which streak-like image defects caused by coating film defects occurring in the process of production of the surface protective layer are reduced as compared with a case where the surface protective layer is a cured film formed of a composition that contains a straight polysiloxane compound and a reactive group-containing charge transport material containing a reactive group and a charge-transporting skeleton in an identical molecule.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

Specific means for achieving the above-described object includes the following aspects.

According to an aspect of the present disclosure, there is provided an electrophotographic photoreceptor including a conductive substrate, a charge generation layer provided on the conductive substrate, a charge transport layer provided on the charge generation layer, and a surface protective layer provided on the charge transport layer, in which the surface protective layer is a cured film formed of a composition that contains a resin (X) having at least one of a unit represented by Formula (X1) or a unit represented by Formula (X2) and a reactive group-containing charge transport material containing a reactive group and a charge-transporting skeleton in an identical molecule,

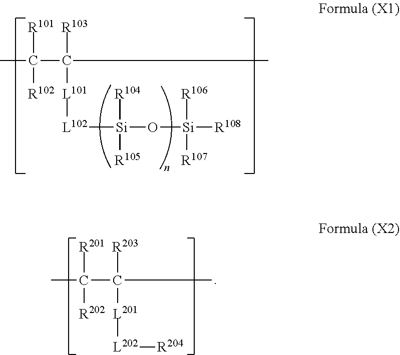

in Formula (X1), R¹⁰¹, R¹⁰², and R¹⁰³ each independently represent a hydrogen atom or an alkyl group having 1 or more and 5 or less carbon atoms, L¹⁰¹ represents a single bond, an alkylene group having 1 or more and 5 or less carbon atoms, —O—, —C(═O)—, —C(═O)O—, an aromatic ring that may have a substituent, or a combination thereof, L¹⁰² represents a single bond, an alkylene group having 1 or more and 5 or less carbon atoms, —O—, —C(═O)—, —C(═O)O—, or a combination thereof, R¹⁰⁴ and R¹⁰⁵ each independently represent an alkyl group having 1 or more and 5 or less carbon atoms, n represents an integer of 0 or greater and 300 or less, R¹⁰⁶, R¹⁰⁷, and R¹⁰⁸ each independently represent an alkyl group having 1 or more and 5 or less carbon atoms or —O—[Si(R¹⁰⁹)(R¹¹⁰)O]ₘ—Si(R¹¹¹)(R¹¹²)(R¹¹³), R¹⁰⁹, R¹¹⁰, R¹¹¹, R¹¹², and R¹¹³ each independently represent an alkyl group having 1 or more and 5 or less carbon atoms, and m represents an integer of 0 or greater and 20 or less,

in Formula (X2), R²⁰¹, R²⁰², and R²⁰³ each independently represent a hydrogen atom or an alkyl group having 1 or more and 5 or less carbon atoms, L²⁰¹ represents a single bond, an alkylene group having 1 or more and 5 or less carbon atoms, —O—, —C(═O)—, —C(═O)O—, an aromatic ring that may have a substituent, or a combination thereof, L²⁰² represents a single bond, an alkylene group having 1 or more and 5 or less carbon atoms, —O—, —C(═O)—, —C(═O)O—, or a combination thereof, and R²⁰⁴ is an alkyl group having 6 or more and 30 or less carbon atoms.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor according to a first exemplary embodiment;

FIG. 2 is a schematic configuration view showing an example of an image forming apparatus according to the present exemplary embodiment; and

FIG. 3 is a schematic configuration diagram showing another example of the image forming apparatus according to the present exemplary embodiment.

### DETAILED DESCRIPTION

Hereinafter, exemplary embodiments of the present disclosure will be described. The following descriptions and examples merely illustrate the exemplary embodiments, and do not limit the scope of the exemplary embodiments.

In the present disclosure, a numerical range shown using “to” indicates a range including numerical values described before and after “to” as a minimum value and a maximum value.

In a numerical range described in a stepwise manner in the present disclosure, an upper limit value or a lower limit value described in a certain numerical range may be replaced with an upper limit value or a lower limit value in another numerical range described in a stepwise manner. Further, in a numerical range described in the present disclosure, an upper limit value or a lower limit value described in the numerical range may be replaced with a value shown in Examples.

In the present disclosure, the meaning of the term “step” includes not only an independent step but also a step whose intended purpose is achieved even in a case where the step is not clearly distinguished from other steps.

In the present disclosure, in a case where an exemplary embodiment is described with reference to drawings, the configuration of the exemplary embodiment is not limited to the configuration shown in the drawings. In addition, the sizes of members in each drawing are conceptual, and a relative relation in the sizes between the members is not limited thereto.

In the present disclosure, each component may include a plurality of kinds of substances corresponding to each component. In the present disclosure, in a case where a plurality of kinds of substances corresponding to each component in a composition are present, the amount of each component in the composition indicates the total amount of the plurality of kinds of substances present in the composition unless otherwise specified.

In the present disclosure, each component may include a plurality of kinds of particles corresponding to each component. In a case where a plurality of kinds of particles corresponding to each component are present in a composition, the particle diameter of each component indicates the value of a mixture of the plurality of kinds of particles present in the composition, unless otherwise specified.

In the present disclosure, an alkyl group and an alkylene group are any of linear, branched, or cyclic unless otherwise specified.

In the present disclosure, a hydrogen atom in an organic group, an aromatic ring, a linking group, an alkyl group, an alkylene group, an aryl group, an aralkyl group, an alkoxy group, an aryloxy group, or the like may be substituted with a halogen atom.

In the present disclosure, a polymer having a siloxane skeleton not in the main chain but in a branch (that is, a graft chain) will be referred to as “graft type polysiloxane compound”.

In the present disclosure, a polymer that does not have a siloxane skeleton in the main chain and has long-chain alkyl in a branch (that is, a graft chain) will be referred to as “graft type long-chain alkyl-based resin”.

In the present disclosure, a polymer having a siloxane skeleton in the main chain will be referred to as “straight polysiloxane compound”.

### Electrophotographic Photoreceptor

An electrophotographic photoreceptor according to the present exemplary embodiment is an electrophotographic photoreceptor including a conductive substrate, a charge generation layer provided on the conductive substrate, a charge transport layer provided on the charge generation layer, and a surface protective layer provided on the charge transport layer, in which the surface protective layer is a cured film formed of a composition that contains a resin (X) having at least one of a unit represented by Formula (X1) or a unit represented by Formula (X2) and a reactive group-containing charge transport material containing a reactive group and a charge-transporting skeleton in an identical molecule.

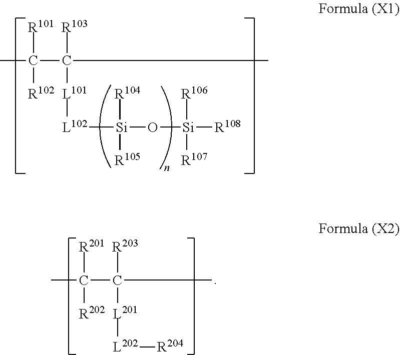

In Formula (X1), R¹⁰¹, R¹⁰², and R¹⁰³ each independently represent a hydrogen atom or an alkyl group having 1 or more and 5 or less carbon atoms, L¹⁰¹ represents a single bond, an alkylene group having 1 or more and 5 or less carbon atoms, —O—, —C(═O)—, —C(═O)O—, an aromatic ring that may have a substituent, or a combination thereof, L¹⁰² represents a single bond, an alkylene group having 1 or more and 5 or less carbon atoms, —O—, —C(═O)—, —C(═O)O—, or a combination thereof, R¹⁰⁴ and R¹⁰⁵ each independently represent an alkyl group having 1 or more and 5 or less carbon atoms, n represents an integer of 0 or greater and 300 or less, R¹⁰⁶, R¹⁰⁷, and R¹⁰⁸ each independently represent an alkyl group having 1 or more and 5 or less carbon atoms or —O—[Si(R¹⁰⁹)(R¹¹⁰)O]m-Si(R¹¹¹)(R¹¹²)(R¹¹³), R¹⁰⁹, R¹¹⁰, R¹¹¹, R¹¹², and R¹¹³ each independently represent an alkyl group having 1 or more and 5 or less carbon atoms, and m represents an integer of 0 or greater and 20 or less.

In Formula (X2), R²⁰¹, R²⁰², and R²⁰³ each independently represent a hydrogen atom or an alkyl group having 1 or more and 5 or less carbon atoms, L²⁰¹ represents a single bond, an alkylene group having 1 or more and 5 or less carbon atoms, —O—, —C(═O)—, —C(═O)O—, an aromatic ring that may have a substituent, or a combination thereof, L²⁰² represents a single bond, an alkylene group having 1 or more and 5 or less carbon atoms, —O—, —C(═O)—, —C(═O)O—, or a combination thereof, and R²⁰⁴ is an alkyl group having 6 or more and 30 or less carbon atoms.

In the related art, in a photoreceptor including a surface protective layer which is a cured film formed of a composition containing a reactive group-containing charge transport material that contains a reactive group and a charge-transporting skeleton in an identical molecule, a lubricant is known to be added to the surface protective layer for the purpose of decreasing the friction coefficient of the photoreceptor so that the life (so-called abrasion life) due to abrasion of the photoreceptor is improved and the image quality stability is maintained.

However, in such a photoreceptor including a surface protective layer containing a lubricant, coating film defects such as excessive moisture or air bubbles being mixed in the coating film or occurrence of coating film unevenness are likely to occur in the process of forming the surface protective layer. Therefore, streak-like image defects are likely to occur in a region where the coating film defects have occurred. Such streak-like image defects are more conspicuous in a high-temperature and high-humidity environment (for example, 30° C. and 85% RH).

Meanwhile, the photoreceptor according to the present exemplary embodiment contains the resin (X) in the cured film. Since the resin (X) is a graft type polysiloxane compound or a graft type long-chain alkyl-based resin, the coating properties are likely to be ensured as appropriate and the film forming properties are excellent in the formation of the surface protective layer as compared with a straight polysiloxane compound or the like of the related art. Further, coating film unevenness is suppressed even in curing accompanied by volume shrinkage in a case where the coating film is dried. As a result, it is considered that streak-like image defects caused by the coating film defects are suppressed.

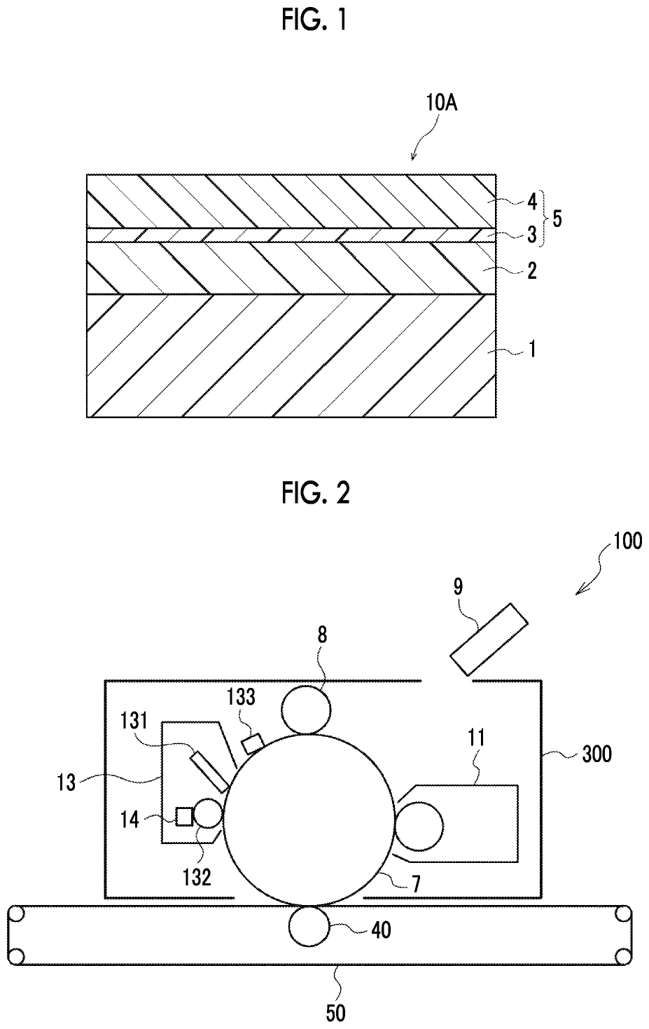

FIG. 1 is a partial cross-sectional view schematically showing an example of a layer configuration of a photoreceptor according to the present exemplary embodiment. A photoreceptor 10A shown in FIG. 1 includes a lamination type photosensitive layer. The photoreceptor 10A has a structure in which an undercoat layer 2, a charge generation layer 3, and a charge transport layer 4 are laminated in this order on a conductive substrate 1, and the charge generation layer 3 and the charge transport layer 4 constitute a photosensitive layer 5 (so-called function separation type photosensitive layer). The photoreceptor 10A may include an interlayer (not shown) between the undercoat layer 2 and the charge generation layer 3.

Hereinafter, each layer of the photoreceptor will be described in detail. Further, the reference numerals are omitted.

### Surface Protective Layer

The surface protective layer is a layer (that is, a layer containing a polymer or a crosslinked body of the reactive group-containing charge transport material) formed of a cured film with a composition that contains a resin (X) having at least one of a unit represented by Formula (X1) or a unit represented by Formula (X2) and a reactive group-containing charge transport material containing a reactive group and a charge-transporting skeleton in an identical molecule.

### Resin (X)

The resin (X) has at least one of a unit (X1) or a unit (X2). The resin (X) may have other constitutional units in addition to the unit (X1) and the unit (X2).

The resin (X) has at least one of the unit (X1) or the unit (X2) and thus is a graft type polymer having a siloxane chain or a long-chain alkyl group in a side chain, and accordingly, the coating properties are likely to be ensured as appropriate and the film forming properties are excellent in the formation of the surface protective layer. Further, coating film unevenness is suppressed even in curing accompanied by volume shrinkage in a case where the coating film is dried. As a result, streak-like image defects caused by the coating film defects are suppressed.

The unit (X1) is a constitutional unit represented by Formula (X1).

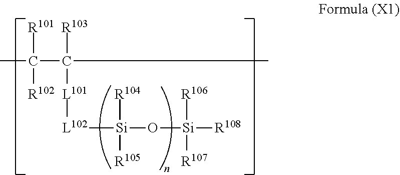

In Formula (X1), R¹⁰¹, R¹⁰², and R¹⁰³ each independently represent a hydrogen atom or an alkyl group having 1 or more and 5 or less carbon atoms, L¹⁰¹ represents a single bond, an alkylene group having 1 or more and 5 or less carbon atoms, —O—, —C(═O)—, —C(═O)O—, an aromatic ring that may have a substituent, or a combination thereof, L¹⁰² represents a single bond, an alkylene group having 1 or more and 5 or less carbon atoms, —O—, —C(═O)—, —C(═O)O—, or a combination thereof, R¹⁰⁴ and R¹⁰⁵ each independently represent an alkyl group having 1 or more and 5 or less carbon atoms, n represents an integer of 0 or greater and 300 or less, R¹⁰⁶, R¹⁰⁷, and R¹⁰⁸ each independently represent an alkyl group having 1 or more and 5 or less carbon atoms or —O—[Si(R¹⁰⁹)(R¹¹⁰)O]m-Si(R¹¹¹)(R¹¹²)(R¹¹³), R¹⁰⁹, R¹¹⁰, R¹¹¹, R¹¹², and R¹¹³ each independently represent an alkyl group having 1 or more and 5 or less carbon atoms, and m represents an integer of 0 or greater and 20 or less.

The alkyl group having 1 or more and 5 or less carbon atoms as R¹⁰¹, R¹⁰², and R¹⁰³ may be linear, branched, or cyclic. The number of carbon atoms of the alkyl group is, for example, preferably 1 or more and 4 or less, more preferably 1 or more and 3 or less, still more preferably 1 or 2, and particularly preferably 1.

R¹⁰¹ and R¹⁰² each independently represent, for example, preferably a hydrogen atom or a methyl group and more preferably a hydrogen atom.

It is preferable that R¹⁰³ represents, for example, a hydrogen atom or a methyl group.

The alkylene group having 1 or more and 5 or less carbon atoms as L¹⁰¹ and L¹⁰² may be linear, branched, or cyclic. The number of carbon atoms of the alkylene group is, for example, preferably 2 or more and 5 or less, more preferably 2 or more and 4 or less, and still more preferably 3.

Examples of the linear alkylene group having 1 or more and 5 or less carbon atoms include a methylene group, an ethylene group, an n-propylene group, an n-butylene group, and an n-pentylene group.

Examples of the branched alkylene group having 3 or more and 5 or less carbon atoms include an isopropylene group, an isobutylene group, a sec-butylene group, a tert-butylene group, an isopentylene group, a neopentylene group, and a tert-pentylene group.

Examples of the cyclic alkylene group having 3 or more and 5 or less carbon atoms include a cyclopropylene group, a cyclobutylene group, and a cyclopentylene group.

The aromatic ring of the aromatic ring that may have a substituent as L¹⁰¹ may be a monocycle or a polycycle. Examples of the aromatic ring include a benzene ring, a naphthalene ring, an anthracene ring, and a phenanthrene ring. Among these, for example, a benzene ring and a naphthalene ring are preferable.

The hydrogen atom of the aromatic ring may be substituted with an alkyl group, an aryl group, an aralkyl group, an alkoxy group, an aryloxy group, a halogen atom, or the like. As the substituent used to substitute the aromatic ring, for example, an alkyl group having 1 or more and 5 or less carbon atoms is preferable, an alkyl group having 1 or more and 3 or less carbon atoms is more preferable, and a methyl group is still more preferable.

L¹⁰¹ represents, for example, preferably —C(═O)O— or an aromatic ring that may have a substituent, more preferably —C(═O)O— or a benzene ring that may have a substituent, and still more preferably —C(═O)O— or a benzene ring.

L¹⁰² represents, for example, preferably a single bond, a linear alkylene group having 1 or more and 5 or less carbon atoms, —O—, —C(═O)—, —C(═O)O—, or a combination thereof and more preferably a linear alkylene group having 2 or more and 4 or less carbon atoms, —O—, —C(═O)—, —C(═O)O—, or a combination thereof.

The alkyl group having 1 or more and 5 or less carbon atoms as R¹⁰⁴ and R¹⁰⁵ may be linear, branched, or cyclic. The number of carbon atoms of the alkyl group is, for example, preferably 1 or more and 4 or less, more preferably 1 or more and 3 or less, still more preferably 1 or 2, and particularly preferably 1.

R¹⁰⁴ and R¹⁰⁵ each independently represent, for example, preferably a linear alkyl group having 1 or more and 5 or less carbon atoms, more preferably a linear alkyl group having 1 or more and 4 or less carbon atoms, and still more preferably a methyl group.

n represents an integer of 0 or greater and 300 or less, for example, preferably an integer of 1 or greater and 250 or less, more preferably an integer of 3 or greater and 200 or less, and still more preferably an integer of 5 or greater and 150 or less.

The alkyl group having 1 or more and 5 or less carbon atoms as R¹⁰⁶, R¹⁰⁷, R¹⁰⁸, R¹⁰⁹, R¹¹⁰, R¹¹¹, R¹¹², and R¹¹³ may be linear, branched, or cyclic. The number of carbon atoms of the alkyl group is, for example, preferably 1 or more and 4 or less, more preferably 1 or more and 3 or less, still more preferably 1 or 2, and particularly preferably 1.

In a case where R¹⁰⁶, R¹⁰⁷, and R¹⁰⁸ each independently represent an alkyl group having 1 or more and 5 or less carbon atoms, R¹⁰⁶, R¹⁰⁷, and R¹⁰⁸ each independently represent, for example, preferably a linear alkyl group having 1 or more and 5 or less carbon atoms, more preferably a linear alkyl group having 1 or more and 4 or less carbon atoms, and still more preferably a methyl group.

R¹⁰⁹, R¹¹⁰, R¹¹¹, R¹¹², and R¹¹³ each independently represent, for example, preferably a linear alkyl group having 1 or more and 5 or less carbon atoms, more preferably a linear alkyl group having 1 or more and 4 or less carbon atoms, and still more preferably a methyl group.

m represents an integer of 0 or greater and 20 or less, for example, preferably an integer of 0 or greater and 15 or less, more preferably an integer of 0 or greater and 10 or less, and still more preferably an integer of 0 or greater and 5 or less.

It is preferable that the unit (X1) is, for example, at least one of a unit (X1-1) represented by Formula (X1-1) or a unit (X1-2) represented by Formula (X1-2).

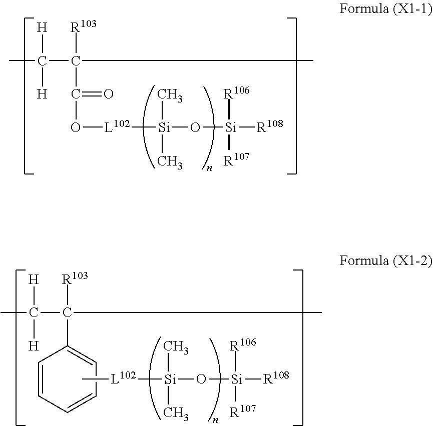

In Formulae (X1-1) and (X1-2), R¹⁰³ represents a hydrogen atom or a methyl group, L¹⁰² represents a single bond, an alkylene group having 1 or more and 5 or less carbon atoms, —O—, —C(═O)—, —C(═O)O—, or a combination thereof, n represents an integer of 0 or greater and 300 or less, R¹⁰⁶, R¹⁰⁷, and R¹⁰⁸ each independently represent an alkyl group having 1 or more and 5 or less carbon atoms or —O—[Si(R¹⁰⁹)(R¹¹⁰)O]m-Si(R¹¹¹)(R¹¹²)(R¹¹³), and R¹⁰⁹, R¹¹⁰, R¹¹¹, R¹¹², and R¹¹³ each independently represent an alkyl group having 1 or more and 5 or less carbon atoms, and m represents an integer of 0 or greater and 20 or less.

R¹⁰³, n, R¹⁰⁶, R¹⁰⁷, R¹⁰⁸, R¹⁰⁹, R¹¹⁰, R¹¹¹, R¹¹², R¹¹³, and m in Formulae (X1-1) and (X1-2) each have the same definition as that for R¹⁰³, n, R¹⁰⁶, R¹⁰⁷, R¹⁰⁸, R¹⁰⁹, R¹¹⁰, R¹¹¹, R¹², R¹¹³, and m in Formula (X1), and the forms thereof are the same as each other.

In Formula (X1-1), L¹⁰² represents, for example, preferably a linear alkylene group having 1 or more and 5 or less carbon atoms or a combination of a linear alkylene group having 1 or more and 5 or less carbon atoms and —O—, more preferably a linear alkylene group having 2 or more and 4 or less carbon atoms or a combination of a linear alkylene group having 2 or more and 4 or less carbon atoms and —O—, and still more preferably a linear alkylene group having 2 or 3 carbon atoms or a combination of a linear alkylene group having 2 or 3 carbon atoms and —O—.

Among the atoms forming L¹⁰², the number of atoms connecting “0” of —C(═O)O— and “Si” of —(Si(CH₃)₂O)n- in Formula (X1-1) at the shortest distance is, for example, preferably 1 or more and 5 or less, more preferably 2 or more and 4 or less, and still more preferably 3 or 4.

In Formula (X1-2), L¹⁰² represents, for example, preferably a linear alkylene group having 1 or more and 5 or less carbon atoms, —O—, —C(═O)—, —C(═O)O—, or a combination thereof, more preferably a linear alkylene group having 1 or more and 4 or less carbon atoms, —O—, —C(═O)—, —C(═O)O—, or a combination thereof, and still more preferably a linear alkylene group having 1 or more and 3 or less carbon atoms, —O—, —C(═O)—, —C(═O)O—, or a combination thereof.

Among the atoms forming L¹⁰², the number of atoms connecting the benzene ring and “Si” of —(Si(CH₃)₂O)n- in Formula (X1-2) at the shortest distance is, for example, preferably 1 or more and 7 or less, more preferably 1 or more and 6 or less, and still more preferably 1 or more and 5 or less.

Specific examples of the unit (X1-1) will be shown below, but the unit (X1-1) is not limited thereto. Me represents a methyl group, and n-Bu represents a normal butyl group.

| | R¹⁰³ | L¹⁰² | n | R¹⁰⁶ | R¹⁰⁷ | R¹⁰⁸ |
|---|---|---|---|---|---|---|
| X1-1-1 | H | —(CH₂)₂— | 5 | Me | Me | Me |
| X1-1-2 | Me | —(CH₂)₂—O—(CH₂)₃— | 35 | Me | Me | Me |
| X1-1-3 | Me | —(CH₂)₂—O—(CH₂)₃— | 61 | Me | Me | Me |
| X1-1-4 | Me | —(CH₂)₃— | 1 | Me | Me | Me |
| X1-1-5 | Me | —(CH₂)₃— | 2 | Me | Me | Me |
| X1-1-6 | Me | —(CH₂)₃— | 3 | Me | Me | Me |
| X1-1-7 | Me | —(CH₂)₃— | 4 | Me | Me | Me |
| X1-1-8 | Me | —(CH₂)₃— | 5 | Me | Me | Me |
| X1-1-9 | Me | —(CH₂)₃— | 6 | Me | Me | Me |
| X1-1-10 | Me | —(CH₂)₃— | 7 | Me | Me | Me |
| X1-1-11 | Me | —(CH₂)₃— | 8 | Me | Me | Me |
| X1-1-12 | Me | —(CH₂)₃— | 9 | Me | Me | Me |
| X1-1-13 | Me | —(CH₂)₃— | 10 | Me | Me | Me |
| X1-1-14 | Me | —(CH₂)₃— | 28 | Me | Me | Me |
| X1-1-15 | Me | —(CH₂)₃— | 29 | Me | Me | Me |
| X1-1-16 | Me | —(CH₂)₃— | 59 | Me | Me | Me |
| X1-1-17 | Me | —(CH₂)₃— | 60 | Me | Me | Me |
| X1-1-18 | Me | —(CH₂)₃— | 65 | Me | Me | Me |
| X1-1-19 | Me | —(CH₂)₃— | 132 | Me | Me | Me |
| X1-1-20 | Me | —(CH₂)₃— | 159 | Me | Me | Me |
| X1-1-21 | Me | —(CH₂)₃— | 160 | Me | Me | Me |
| X1-1-22 | Me | —(CH₂)₃— | 267 | Me | Me | Me |
| X1-1-23 | Me | —(CH₂)₃— | 10 | n-Bu | Me | Me |
| X1-1-24 | Me | —(CH₂)₃— | 11 | n-Bu | Me | Me |
| X1-1-25 | Me | —(CH₂)₃— | 64 | n-Bu | Me | Me |
| X1-1-26 | Me | —(CH₂)₃— | 65 | n-Bu | Me | Me |
| X1-1-27 | Me | —(CH₂)₃— | 131 | n-Bu | Me | Me |
| X1-1-28 | Me | —(CH₂)₃— | 132 | n-Bu | Me | Me |
| X1-1-29 | Me | —(CH₂)₃— | 0 | —O—SiMe₃ | —O—SiMe₃ | —O—SiMe₃ |
| X1-1-30 | Me | —(CH₂)₃— | 5 | n-Bu | Me | Me |
| X1-1-31 | Me | —(CH₂)₃— | 7 | n-Bu | Me | Me |
| X1-1-32 | Me | —(CH₂)₃— | 8 | n-Bu | Me | Me |
| X1-1-33 | Me | —(CH₂)₃— | 10 | n-Bu | Me | Me |
| X1-1-34 | Me | —(CH₂)₃— | 11 | n-Bu | Me | Me |
| X1-1-35 | Me | —(CH₂)₃— | 131 | n-Bu | Me | Me |
| X1-1-36 | Me | —(CH₂)₃— | 132 | n-Bu | Me | Me |
| X1-1-37 | Me | —(CH₂)₃— | 0 | —O—SiMe₃ | —O—SiMe₃ | Me |
| X1-1-38 | Me | —(CH₂)₃— | 0 | —O—(SiMe₂O)₃—Si(n-Bu)Me₂ | —O—(SiMe₂O)₃—Si(n-Bu)Me₂ | Me |
| X1-1-39 | Me | —(CH₂)₃— | 0 | —O—(SiMe₂O)₄—Si(n-Bu)Me₂ | —O—(SiMe₂O)₄—Si(n-Bu)Me₂ | Me |
| X1-1-40 | Me | —(CH₂)₃— | 0 | —O—(SiMe₂O)₁—SiMe₃ | —O—(SiMe₂O)₁—SiMe₃ | —O—(SiMe₂O)₁—SiMe₃ |
| X1-1-41 | H | —(CH₂)₃— | 0 | —O—(SiMe₂O)₁—SiMe₃ | —O—(SiMe₂O)₁—SiMe₃ | —O—(SiMe₂O)₁—SiMe₃ |
| X1-1-42 | H | —(CH₂)₃— | 0 | —O—(SiMe₂O)₂—SiMe₃ | —O—(SiMe₂O)₂—SiMe₃ | —O—(SiMe₂O)₂—SiMe₃ |

Specific examples of the unit (X1-2) will be shown below, but the unit (X1-2) is not limited thereto. Me represents a methyl group, and n-flu represents a normal butyl group.

| | R¹⁰³ | L¹⁰² | n | R¹⁰⁶ | R¹⁰⁷ | R¹⁰⁸ |
|---|---|---|---|---|---|---|
| X1-2-1 | H | —O— | 0 | Me | Me | Me |
| X1-2-2 | H | —O— | 1 | Me | Me | Me |
| X1-2-3 | H | —O— | 2 | Me | Me | Me |
| X1-2-4 | H | —O— | 3 | Me | Me | Me |
| X1-2-5 | H | —O— | 4 | Me | Me | Me |
| X1-2-6 | H | —O— | 8 | Me | Me | Me |
| X1-2-7 | H | —O— | 10 | Me | Me | Me |
| X1-2-8 | H | —O— | 20 | Me | Me | Me |
| X1-2-9 | H | —(C═O)O—(CH₂)₂—O—(CH₂)₃— | 35 | Me | Me | Me |
| X1-2-10 | H | —(C═O)O—(CH₂)₂—O—(CH₂)₃— | 61 | Me | Me | Me |
| X1-2-11 | H | —O(C═O)—(CH₂)₂— | 18 | Me | Me | Me |
| X1-2-12 | H | —CH₂—O(C═O)—(CH₂)₂— | 18 | Me | Me | Me |
| X1-2-13 | H | —(C═O)O—(CH₂)₂—O—(CH₂)₃— | 11 | n-Bu | Me | Me |
| X1-2-14 | H | —(C═O)O—(CH₂)₂—O—(CH₂)₃— | 65 | n-Bu | Me | Me |
| X1-2-15 | H | —(C═O)O—(CH₂)₂—O—(CH₂)₃— | 132 | n-Bu | Me | Me |
| X1-2-16 | H | —(C═O)O—(CH₂)₃— | 0 | —O—SiMe₃ | —O—SiMe₃ | Me |

Specific examples of the unit (X1) other than the unit (X1-1) and the unit (X1-2) will be shown below, but the unit (X1) is not limited thereto. Me represents a methyl group, Et represents an ethyl group, and Ph represents a phenyl group.

| | R¹⁰¹ | R¹⁰² | R¹⁰³ | L¹⁰¹ | L¹⁰² | n | R¹⁰⁴ | R¹⁰⁵ | R¹⁰⁶ | R¹⁰⁷ | R¹⁰⁸ |
|---|---|---|---|---|---|---|---|---|---|---|---|
| X1-E-1 | H | H | H | Single bond | Single bond | 72 | Me | Me | Me | Me | Me |
| X1-E-2 | H | H | H | Single bond | Single bond | 86 | Me | Me | Me | Me | Me |
| X1-E-3 | H | H | H | Single bond | Single bond | 0 | — | | Me | Me | Me |
| X1-E-4 | H | H | H | Single bond | Single bond | 0 | — | — | Et | Et | Et |
| X1-E-5 | H | H | H | Single bond | Single bond | 0 | — | — | —O—SiMe₃ | —O—SiMe₃ | —O—SiMe₃ |
| X1-E-6 | H | H | H | Single bond | Single bond | 1 | Me | Me | Me | Me | Me |
| X1-E-7 | H | H | H | Single bond | Single bond | 0 | — | — | Me | Me | Me |

The unit (X2) is a constitutional unit represented by Formula (X2).

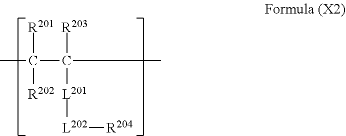

In Formula (X2), R²⁰¹, R²⁰², and R²⁰³ each independently represent a hydrogen atom or an alkyl group having 1 or more and 5 or less carbon atoms, L²⁰¹ represents a single bond, an alkylene group having 1 or more and 5 or less carbon atoms, —O—, —C(═O)—, —C(═O)O—, an aromatic ring that may have a substituent, or a combination thereof, L²⁰² represents a single bond, an alkylene group having 1 or more and 5 or less carbon atoms, —O—, —C(═O)—, —C(═O)O—, or a combination thereof, and R²⁰⁴ is an alkyl group having 6 or more and 30 or less carbon atoms.

The alkyl group having 1 or more and 5 or less carbon atoms as R²⁰¹, R²⁰², and R²⁰³ may be any of linear, branched, or cyclic. The number of carbon atoms of the alkyl group is, for example, preferably 1 or more and 4 or less, more preferably 1 or more and 3 or less, still more preferably 1 or 2, and particularly preferably 1.

R²⁰¹ and R²⁰² each independently represent, for example, preferably a hydrogen atom or a methyl group and more preferably a hydrogen atom.

It is preferable that R²⁰³ represents, for example, a hydrogen atom or a methyl group.

The alkylene group having 1 or more and 5 or less carbon atoms as L²⁰¹ and L²⁰² may be linear, branched, or cyclic. The number of carbon atoms of the alkylene group is, for example, preferably 2 or more and 5 or less, more preferably 2 or more and 4 or less, and still more preferably 3.

Examples of the linear alkylene group having 1 or more and 5 or less carbon atoms include a methylene group, an ethylene group, an n-propylene group, an n-butylene group, and an n-pentylene group.

Examples of the branched alkylene group having 3 or more and 5 or less carbon atoms include an isopropylene group, an isobutylene group, a sec-butylene group, a tert-butylene group, an isopentylene group, a neopentylene group, and a tert-pentylene group.

Examples of the cyclic alkylene group having 3 or more and 5 or less carbon atoms include a cyclopropylene group, a cyclobutylene group, and a cyclopentylene group.

The aromatic ring of the aromatic ring that may have a substituent as L²⁰¹ may be any of a monocycle or a polycycle. Examples of the aromatic ring include a benzene ring, a naphthalene ring, an anthracene ring, and a phenanthrene ring. Among these, for example, a benzene ring and a naphthalene ring are preferable.

The hydrogen atom of the aromatic ring may be substituted with an alkyl group, an aryl group, an aralkyl group, an alkoxy group, an aryloxy group, a halogen atom, or the like. As the substituent used to substitute the aromatic ring, for example, an alkyl group having 1 or more and 5 or less carbon atoms is preferable, an alkyl group having 1 or more and 3 or less carbon atoms is more preferable, and a methyl group is still more preferable.

L²⁰¹ represents, for example, preferably —C(═O)O— or an aromatic ring that may have a substituent, more preferably —C(═O)O— or a benzene ring that may have a substituent, and still more preferably —C(═O)O— or a benzene ring.

L²⁰² represents, for example, preferably a single bond, a linear alkylene group having 1 or more and 4 or less carbon atoms, —O—, —C(═O)—, —C(═O)O—, or a combination thereof and more preferably a single bond, a linear alkylene group having 1 or more and 3 or less carbon atoms, —O—, —C(═O)—, —C(═O)O—, or a combination thereof.

The alkyl group having 6 or more and 30 or less carbon atoms as R²⁰⁴ may be linear, branched, or cyclic and is, for example, preferably linear or branched. The number of carbon atoms of the alkyl group is, for example, preferably 8 or more and 28 or less, more preferably 9 or more and 26 or less, and still more preferably 10 or more and 25 or less.

Examples of the linear alkyl group having 6 or more and 30 or less carbon atoms include an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-heptadecyl group, an n-octadecyl group, an n-nonadecyl group, an n-icosyl group, and an n-docosyl group.

Examples of the branched alkyl group having 6 or more and 30 or less carbon atoms include an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 6 or more and 30 or less carbon atoms include a cyclohexyl group, a cycloheptyl group, a cyclooctyl group, a cyclononyl group, a cyclodecyl group, and polycyclic (such as bicyclic, tricyclic, or spirocyclic) alkyl groups formed by these monocyclic alkyl groups being linked to each other.

R²⁰⁴ represents, for example, preferably a linear alkyl group or a branched alkyl group having 6 or more and 30 or less carbon atoms, more preferably a linear alkyl group or a branched alkyl group having 8 or more and 28 or less carbon atoms, still more preferably a linear alkyl group or a branched alkyl group having 9 or more and 26 or less carbon atoms, and particularly preferably a linear alkyl group or a branched alkyl group having 10 or more and 25 or less carbon atoms.

It is preferable that the unit (X2) is, for example, at least one of a unit (X2-1) represented by Formula (X2-1) or a unit (X2-2) represented by Formula (X2-2).

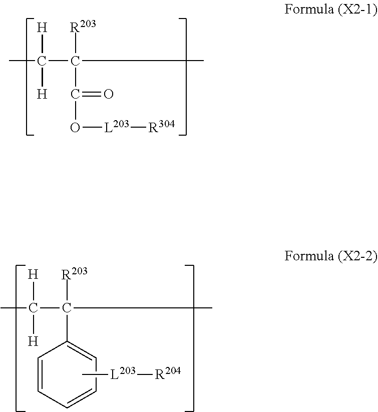

In Formulae (X2-1) and (X2-2), R²⁰³ represents a hydrogen atom or a methyl group, L²⁰² represents a single bond, an alkylene group having 1 or more and 5 or less carbon atoms, —O—, —C(═O)—, —C(═O)O—, or a combination thereof, and R²⁰⁴ represents an alkyl group having 6 or more and 30 or less carbon atoms.

R²⁰³ and R²⁰⁴ in Formulae (X2-1) and (X2-2) each have the same definition as that for R²⁰³, L²⁰², and R²⁰⁴ in Formula (X2), and the forms thereof are the same as each other.

It is preferable that L²⁰² in Formula (X2-1) represents, for example, a single bond.

In Formula (X2-2), L²⁰² represents, for example, preferably a single bond, a linear alkylene group having 1 or more and 4 or less carbon atoms, —O—, —C(═O)—, —C(═O)O—, or a combination thereof and more preferably a single bond, a linear alkylene group having 1 or more and 3 or less carbon atoms, —O—, —C(═O)—, —C(═O)O—, or a combination thereof.

Among the atoms forming L²⁰², the number of atoms connecting the benzene ring and R²⁰⁴ in Formula (X2-2) at the shortest distance is, for example, preferably 1 or more and 5 or less, more preferably 1 or more and 3 or less, and still more preferably 1 or 2.

Specific examples of the unit (X2-1) will be shown below, but the unit (X2-1) is not limited thereto. Me represents a methyl group.

| | R [symbol] | L [symbol] | R [symbol] |
|---|---|---|---|
| X2-1-1 | H | Single bond | n-C [symbol] H [symbol] |
| X2-1-2 | Me | Single bond | n-C [symbol] H [symbol] |
| X2-1-3 | H | Single bond | n-C [symbol] H [symbol] |
| X2-1-4 | Me | Single bond | n-C [symbol] H [symbol] |
| X2-1-5 | H | Single bond | n-C [symbol] H [symbol] |
| X2-1-6 | Me | Single bond | n-C [symbol] H [symbol] |
| X2-1-7 | H | Single bond | n-C [symbol] H [symbol] |
| X2-1-8 | Me | Single bond | n-C [symbol] H [symbol] |
| X2-1-9 | H | Single bond | n-C [symbol] H [symbol] |
| X2-1-10 | Me | Single bond | n-C [symbol] H [symbol] |
| X2-1-11 | H | Single bond | n-C [symbol] H [symbol] |
| X2-1-12 | Me | Single bond | n-C [symbol] H [symbol] |
| X2-1-13 | H | Single bond | n-C [symbol] H [symbol] |
| X2-1-14 | Me | Single bond | n-C [symbol] H [symbol] |
| X2-1-15 | H | Single bond | —CH [symbol] —CH(C [symbol] H [symbol] )-n-C [symbol] H [symbol] |
| X2-1-16 | Me | Single bond | —CH [symbol] —CH(C [symbol] H [symbol] )-n-C [symbol] H [symbol] |

[symbol]

indicates data missing or illegible when filed

| | R [symbol] | L [symbol] | R [symbol] |
|---|---|---|---|
| X2-1-17 | H | Single bond | n-C [symbol] H [symbol] |
| X2-1-18 | Me | Single bond | n-C [symbol] H [symbol] |
| X2-1-19 | H | Single bond | n-C [symbol] H [symbol] |
| X2-1-20 | Me | Single bond | n-C [symbol] H [symbol] |
| X2-1-21 | H | Single bond | n-C [symbol] H [symbol] |
| X2-1-22 | Me | Single bond | n-C [symbol] H [symbol] |
| X2-1-23 | H | Single bond | —CH [symbol] —CH(n-C [symbol] H [symbol] )-n-C [symbol] H [symbol] |
| X2-1-24 | Me | Single bond | —CH [symbol] —CH(n-C [symbol] H [symbol] )-n-C [symbol] H [symbol] |

[symbol]

indicates data missing or illegible when filed

Specific examples of the unit (X2-2) will be shown below, but the unit (X2-2) is not limited thereto.

| | R²⁰³ | L²⁰² | R²⁰⁴ |
|---|---|---|---|
| X2-2-1 | H | —O—(C═O)— | n-C₆H₁₃ |
| X2-2-2 | H | —O—(C═O)— | n-C₇H₁₅ |
| X2-2-3 | H | —O—(C═O)— | n-C₁₁H₂₃ |
| X2-2-4 | H | —O—(C═O)— | n-C₁₇H₃₅ |
| X2-2-5 | H | —O—(C═O)— | n-C₂₁H₄₃ |
| X2-2-6 | H | —O—(C═O)— | —CH(C₂H₅)-n-C₄H₉ |
| X2-2-7 | H | —O—(C═O)— | —CH(n-C₆H₁₃)-n-C₈H₁₇ |
| X2-2-8 | H | —O—(C═O)— | n-C₂₅H₅₁ |
| X2-2-9 | H | —O—(C═O)— | n-C₂₇H₅₅ |
| X2-2-10 | H | —O—(C═O)— | n-C₂₉H₅₉ |
| X2-2-11 | H | —O— | n-C₁₈H₃₇ |
| X2-2-12 | H | —O— | n-C₂₂H₄₅ |
| X2-2-13 | H | —(C═O)O— | n-C₁₈H₃₇ |
| X2-2-14 | H | —(C═O)O— | n-C₂₂H₄₅ |
| X2-2-15 | H | —CH₂—O—(C═O)— | n-C₁₇H₃₅ |
| X2-2-16 | H | —CH₂—O—(C═O)— | n-C₂₁H₄₃ |

Specific examples of the unit (X2) other than the unit (X2-1) and the unit (X2-2) will be shown below, but the unit (X2) is not limited thereto.

| | R²⁰¹ | R²⁰² | R²⁰³ | L²⁰¹ | L²⁰² | R₂₀₄ |
|---|---|---|---|---|---|---|
| X2-E-1 | H | H | H | —O—(C═O)— | Single bond | n-C₁₁H [symbol] |
| X2-E-2 | H | H | H | —O—(C═O)— | Single bond | n-C [symbol] H [symbol] |
| X2-E-3 | H | H | H | —O—(C═O)— | Single bond | n-C₂₁H₄₃ |
| X2-E-4 | H | H | H | —O—(C═O)— | Single bond | —CH(n-C [symbol] H [symbol] )—n-C [symbol] H [symbol] |
| X2-E-5 | H | H | H | —O— | Single bond | n-C [symbol] H [symbol] |
| X2-E-6 | H | H | H | —O— | Single bond | n-C [symbol] H₃₇ |
| X2-E-7 | H | H | H | —CH₂—O— | Single bond | n-C₁₂H₂₅ |
| X2-E-8 | H | H | H | —CH₂—O— | Single bond | n-C [symbol] H₃₇ |

[symbol]

indicates data missing or illegible when filed

It is preferable that the resin (X) has, for example, both a unit represented by Formula (X1) and a unit represented by Formula (X2). In a case where the resin has both the two units, since the coating properties of the resin (X) are maintained as appropriate, coating film defects caused by generation of air bubbles in the coating film due to an extreme increase in viscosity of a coating solution or occurrence of coating film unevenness due to an extreme decrease in viscosity of a coating solution in a case of applying the coating solution containing the resin (X) in the process of producing the surface protective layer are further suppressed.

It is preferable that the resin (X) further has, for example, a unit represented by Formula (X3). In a case where the resin further has a unit represented by Formula (X3), since the coating properties of the resin (X) are maintained as appropriate, coating film defects caused by generation of air bubbles in the coating film due to an [symbol] reme increase in viscosity of a coating solution or occurrence of coating film unevenness due to an extremely decrease in viscosity of a coating solution in a case of applying the coating solution containing the resin (X) in the process of producing the surface protective layer are further suppressed.

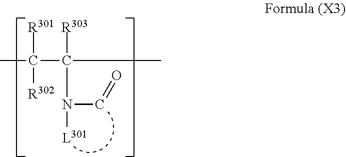

In Formula (X3), R³⁰¹, R³⁰², and R³⁰³ each independently represent a hydrogen atom or an alkyl group having 1 or more and 5 or less carbon atoms, and L³⁰¹ represents an alkylene group having 3 or more and 10 or less carbon atoms which may have a substituent.

The alkyl group having 1 or more and 5 or less carbon atoms as R³⁰¹, R³⁰², and R³⁰³ may be any of linear, branched, or cyclic. The number of carbon atoms of the alkyl group is, for example, preferably 1 or more and 4 or less, more preferably 1 or more and 3 or less, still more preferably 1 or 2, and particularly preferably 1.

R³⁰¹, R³⁰², and R³⁰³ each independently represent, for example, preferably a hydrogen atom or a methyl group and more preferably a hydrogen atom.

The alkylene group having 3 or more and 10 or less carbon atoms as L³⁰¹ may be linear, branched, or cyclic. The number of carbon atoms of the alkylene group is, for example, preferably 3 or more and 8 or less, more preferably 3 or more and 6 or less, and still more preferably 3 or more and 5 or less.

Examples of the linear alkylene group having 3 or more and 10 or less carbon atoms include an n-propylene group, an n-butylene group, an n-pentylene group, an n-hexylene group, an n-heptylene group, an n-octylene group, an n-nonylene group, and an n-decanylene group.

Examples of the branched alkylene group having 3 or more and 10 or less carbon atoms include an isopropylene group, an isobutylene group, a sec-butylene group, a tert-butylene group, an isopentylene group, a neopentylene group, a tert-pentylene group, a 2-propylpropylene group, a 2-butylpropylene group, a 2-ethylpropylene group, a 2-methylpropylene group, a 1-ethyl-2-methyl-propylene group, a 1-propyl-2-methyl-propylene group, a 1-methyl-2-ethyl-propylene group, a 1-propylpropylene group, a 1-butylpropylene group, and a 2-methyl-pentylene group.

Examples of the cyclic alkylene group having 3 or more and 10 or less carbon atoms include a cyclopropylene group, a cyclobutylene group, a cyclopentylene group, a cyclohexylene group, a cycloheptylene group, a cyclooctylene group, a cyclononylene group, and a cyclodecanylene group.

Specific examples of the unit (X3) will be shown below, but the unit (X3) is not limited thereto.

| | R³⁰¹ | R³⁰² | R³⁰³ | L³⁰¹ |
|---|---|---|---|---|
| X3-1 | H | H | H | —CH₂CH₂CH₂— |
| X3-2 | H | H | H | ——CH₂CH₂CH₂CH₂CH₂— |
| X3-3 | H | H | H | —CH₂CH(C₄H₉)CH₂— |
| X3-4 | H | H | H | —CH₂CH(C₃H₇)CH₂— |
| X3-5 | H | H | H | —CH₂CH(C₂H₅)CH₂— |
| X3-6 | H | H | H | —CH₂CH(CH₃)CH₂— |
| X3-7 | H | H | H | —CH(C₂H₅)CH(CH₃)CH₂— |
| X3-8 | H | H | H | —CH(C₃H₇)CH(CH₃)CH₂— |
| X3-9 | H | H | H | —CH(CH₃)CH(C₂H₅)CH₂— |
| X3-10 | H | H | H | —CH(C₃H₇)CH₂CH₂— |
| X3-11 | H | H | H | —CH(C₄H₉)CH₂CH₂— |
| X3-12 | H | H | H | —CH₂CH₂CH₂CH(CH₃)CH₂— |

The unit (X1) of the resin (X) may be used alone or in combination of two or more kinds thereof.

The unit (X2) of the resin (X) may be used alone or in combination of two or more kinds thereof.

The unit (X3) of the resin (X) may be used alone or in combination of two or more kinds thereof.

The resin (X) may have other constitutional units in addition to the unit (X1), the unit (X2), and the unit (X3). Hereinafter, the other constitutional units are also referred to as a unit (X4). The unit (X4) may be used alone or in combination of two or more kinds thereof.

Examples of the unit (X4) include a unit derived from a styrene-based monomer and a unit derived from an acrylic monomer.

Examples of the styrene-based monomer include styrene and vinylnaphthalene; lower alkyl-substituted styrene such as α-methylstyrene, o-methylstyrene, m-methylstyrene, p-methylstyrene, p-ethylstyrene, 2,4-dimethylstyrene, p-n-butylstyrene, or p-tert-butylstyrene; aryl-substituted styrene such as p-phenylstyrene; lower alkoxy-substituted styrene such as p-methoxystyrene; and halogen-substituted styrene such as p-chlorostyrene, 3,4-dichlorostyrene, p-fluorostyrene, or 2,5-difluorostyrene.

Examples of the acrylic monomer include (meth)acrylic acid; (meth)acrylic acid lower alkyl ester such as methyl (meth)acrylate, ethyl (meth)acrylate, propyl (meth)acrylate, isopropyl (meth)acrylate, n-butyl (meth)acrylate, isobutyl (meth)acrylate, or n-pentyl (meth)acrylate; and benzyl (meth)acrylate. The term “(meth)acryl” may denote any of “acryl” or “methacryl”.

Examples of the unit (X4) include units derived from the following monomers.

Examples of the monomers include an olefin such as isoprene, butene, or butadiene; vinyl ether such as vinyl methyl ether or vinyl isobutyl ether; and vinyl ketone such as vinyl methyl ketone, vinyl ethyl ketone, or vinyl isopropenyl ketone.

As the unit (X4), for example, at least one selected from the group consisting of a unit derived from styrene, a unit derived from (meth)acrylic acid, and a unit derived from (meth)acrylic acid lower alkyl ester is preferable, at least one selected from the group consisting of a unit derived from styrene and a unit derived from (meth)acrylic acid lower alkyl ester is more preferable, and at least one selected from the group consisting of a unit derived from styrene, a unit derived from methyl (meth)acrylate, and a unit derived from ethyl (meth)acrylate is still more preferable.

The total content of the unit (X1), the unit (X2), and the unit (X3) contained in the resin (X) is, for example, preferably 10% by mole or greater and 95% by mole or less, more preferably 15% by mole or greater and 90% by mole or less, and still more preferably 20% by mole or greater and 80% by mole or less.

That is, the content of the unit (X3) in the resin (X) is, for example, preferably 5% by mole or greater and 90% by mole or less, more preferably 10% by mole or greater and 85% by mole or less, and still more preferably 20% by mole or greater and 80% by mole or less.

From the viewpoints of improvement of the life due to abrasion of the photoreceptor and the image quality stability, the mass proportion of the resin (X) in the surface protective layer is, for example, preferably 0.01% by mass or greater and 10.00% by mass or less, more preferably 0.01% by mass or greater and 5% by mass or less, and still more preferably 0.1% by mass or greater and 1% by mass or less.

The mass proportion of the resin (X) to the surface protective layer may be 0.01% by mass or greater and 0.30% by mass or less.

Since a lubricant of the related art such as a straight polysiloxane compound ensures the coating properties in a case of being added to a reactive cured film, the mass proportion of the lubricant in the surface protective layer is known to be 0.30% by mass or greater. Meanwhile, since the resin (X) in the present exemplary embodiment has at least one of the unit represented by Formula (X1) or the unit represented by Formula (X2), more satisfactory coating properties are likely to be obtained with a small amount of the resin and the compatibility is also higher compared with a lubricant of the related art. Therefore, even in a case where the mass proportion of the resin (X) is in a range of 0.01% by mass or greater and 0.30% by mass or less in the photoreceptor according to the present exemplary embodiment, streak-like image defects caused by the coating film defects occurring in the process of producing the surface protective layer are suppressed.

In a case where the mass proportion of the resin (X) is 0.01% by mass or greater, the coating properties of the surface protective layer are likely to be ensured, and thus coating film defects are further suppressed. In a case where the mass proportion of the resin (X) is 0.30% by mass or less, coating film defects caused by generation of air bubbles or the like in the coating film due to an extreme increase in viscosity of the coating solution due to an extremely high proportion of the resin (X) are further suppressed in a case of application of the coating solution containing the resin (X) in the process of producing the surface protective layer.

The weight-average molecular weight of the resin (X) is, for example, preferably 1,000 or greater and 30,000 or less, more preferably 1,000 or greater and 10,000 or less, and still more preferably 1,000 or greater and 8,000 or less.

In a case where the weight-average molecular weight of the resin (X) is 1,000 or greater, the coating properties of the surface protective layer are likely to be ensured, and thus the coating film defects are further suppressed.

In a case where the weight-average molecular weight of the resin (X) is 30,000 or less, coating film defects caused by generation of air bubbles or the like in the coating film due to an extreme increase in viscosity of the coating solution are further suppressed in a case of application of the coating solution containing the resin (X) in the process of producing the surface protective layer.

The molecular weight of the resin (X) is a molecular weight measured by gel permeation chromatography (GPC) in terms of polystyrene. The measurement according to GPC is performed by a method of the related art using, for example, tetrahydrofuran or chloroform as an eluent.

Examples of a method of producing the resin (X) include chain polymerization of a monomer providing a unit (X1), a monomer providing a unit (X2), and a monomer providing a unit (X3). Examples of the method of chain polymerization include radical polymerization, coordination polymerization, and ionic polymerization (such as cationic polymerization or anionic polymerization). Among these, from the viewpoints of polymerization control and the versatility such as the application range, for example, radical polymerization is preferable.

### Reactive Group-Containing Charge Transport Material

Examples of the reactive group of the reactive group-containing charge transport material include known reactive groups such as a chain polymerizable group, an epoxy group, —OH, —OR [here, R represents an alkyl group], —NH₂, —SH, —COOH, and —SiR^{Q1}_{3-Qn}(OR^{Q2})_{Qn} [here, R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain polymerizable group is not particularly limited as long as the group is a functional group capable of radical polymerization and is, for example, a functional group containing a group having at least a carbon double bond. Specific examples thereof include a vinyl group, a vinyl ether group, a vinyl thioether group, a styryl group (vinylphenyl group), an acryloyl group, a methacryloyl group, and a group containing at least one selected from derivatives thereof. Among these, from the viewpoint that the reactivity is excellent, for example, a vinyl group, a styryl group (vinylphenyl group), an acryloyl group, a methacryloyl group, and a group containing at least one selected from derivatives thereof are preferable as the chain polymerizable group.

The charge-transporting skeleton of the reactive group-containing charge transport material is not particularly limited as long as the skeleton is a known structure in the electrophotographic photoreceptor, and examples thereof include a structure conjugated with a nitrogen atom, which is a skeleton derived from a nitrogen-containing positive hole-transporting compound such as a triazine-based compound, a triarylamine-based compound, a benzidine-based compound, or a hydrazone-based compound. Among these, from the viewpoint of the charge transport performance, for example, a skeleton derived from at least one of a triarylamine-based compound or a triazine-based compound is preferable.

The reactive group-containing charge transport material may be selected from known materials.

The reactive group-containing charge transport material may be used alone or in combination of two or more kinds thereof.

It is preferable that the surface protective layer contains, for example, at least one reactive group-containing charge transport material having at least one substituent selected from the group consisting of —OH, —OCH₃, —NH₂, —SH, and —COOH (hereinafter, also referred to as “specific charge transport material”) as the reactive group-containing charge transport material.

The cured film formed of a composition containing the specific charge transport material is formed such that residual OH, water, or the like is difficult to generate in the film and the formation of a coating film is unlikely to be affected by the moisture in the atmosphere. Therefore, in a case of the cured film having a composition containing these compounds, the coating film defects are more suppressed in the formation of the surface protective layer, and the streak-like image defects are also further suppressed.

### Specific Charge Transport Material

The specific charge transport material denotes a charge transport material having at least one substituent selected from the group consisting of —OH, —OCH₃, —NH₂, —SH, and —COOH.

From the viewpoint that residual OH and the like are difficult to generate in the film and the formation of the coating film is unlikely to be affected by the moisture in the atmosphere so that the coating film defects are further suppressed, it is more preferable that the specific charge transport material is, for example, a charge transport material having at least one substituent from —OCH₃ or —SH.

From the viewpoint of suppressing abrasion of a foreign matter removing member and suppressing abrasion of the electrophotographic photoreceptor, it is desirable that the specific charge transport material is, for example, a compound represented by General Formula (I).

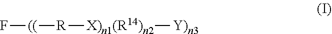

In General Formula (I), F represents an organic group derived from a compound having a positive hole-transporting ability, R¹³ and R¹⁴ each independently represent a linear or branched alkylene group having 1 or more and 5 or less carbon atoms, n1 represents 0 or 1, n2 represents 0 or 1, and n3 represents an integer of 1 or greater and 4 or less. X represents an oxygen atom, NH, or a sulfur atom, and Y represents —OH, —OCH₃, —NH₂, —SH, or —COOH.

In General Formula (I), examples of the compound having a positive hole-transporting ability in the organic group derived from the compound having a positive hole-transporting ability represented by F include an arylamine derivative. Examples of the arylamine derivative include a triphenylamine derivative and a tetraphenylbenzidine derivative.

The compound represented by General Formula (I) is, for example, desirably a compound represented by General Formula (II). The compound represented by General Formula (II) is particularly excellent in charge mobility, stability to oxidation, and the like.

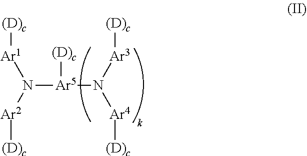

In General Formula (II), Ar¹ to Ar⁴ may be the same as or different from each other and each independently represent a substituted or unsubstituted aryl group, Ar⁵ represents a substituted or unsubstituted aryl group or a substituted or unsubstituted arylene group, D represents -(—R¹³—X)ₙ₁(R¹⁴)n2-Y, c's each independently represent 0 or 1, k represents 0 or 1, and the total number of D's is 1 or more and 4 or less. Further, R¹³ and R¹⁴ each independently represent a linear or branched alkylene group having 1 or more and 5 or less carbon atoms, n1 represents 0 or 1, n2 represents 0 or 1, X represents an oxygen atom, NH, or a sulfur atom, and Y represents —OH, —OCH₃, —NH₂, —SH, or —COOH.

In General Formula (II), “-(—R¹³—X)ₙ₁(R¹⁴)ₙ₂—Y” represented by D has the same definition as that for General Formula (I), and R¹³ and R¹⁴ each independently represent a linear or branched alkylene group having 1 or more and 5 or less carbon atoms. Further, it is preferable that n1 represents, for example, 1. Further, it is preferable that n2 represents, for example, 1. Further, it is preferable that X represents, for example, an oxygen atom. Further, it is preferable that Y represents, for example, a hydroxyl group.

The total number of D's in General Formula (II) corresponds to n3 in General Formula (I) and is, for example, preferably 2 or greater and 4 or less and more preferably 3 or greater and 4 or less.

In General Formula (I) or General Formula (II), in a case where the total number of D's is set to 2 or greater and 4 or less, for example, preferably 3 or greater and 4 or less in one molecule, the crosslinking density is increased and a crosslinked film with higher strength is likely to be obtained.

In General Formula (II), it is desirable that Ar₁ to Ar₄ represent, for example, any of Formulae (1) to (7). Further, Formulae (1) to (7) are shown together with “-(D)_{C}” that can be linked to each of A₁ to Ar₄.

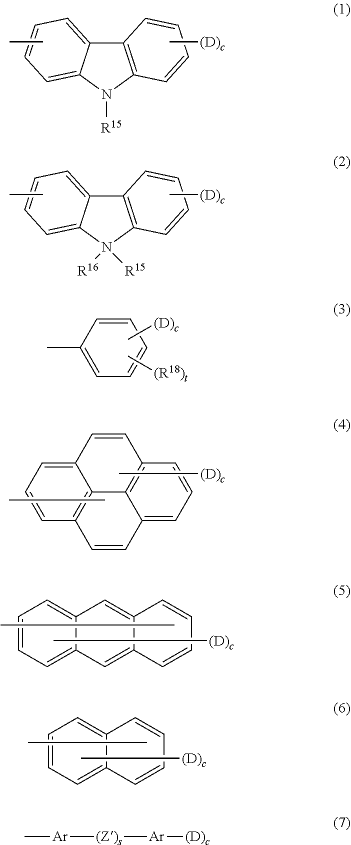

In Formulae (1) to (7), R¹⁵ represents one selected from the group consisting of a hydrogen atom, an alkyl group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, and an aralkyl group having 7 or more and 10 or less carbon atoms, R¹⁶ to R¹⁸ each independently represent one selected from the group consisting of a hydrogen atom, an alkyl group having 1 or more and 4 or less carbon atoms, an alkoxy group having 1 or more and 4 or less carbon atoms, a phenyl group substituted with an alkoxy group having 1 or more and 4 or less carbon atoms, an unsubstituted phenyl group, an aralkyl group having 7 or more and 10 or less carbon atoms, and a halogen atom, Ar represents a substituted or unsubstituted arylene group, D and c each have the same definition as that for “D” and “c” in General Formula (II), s represents 0 or 1, and t represents an integer of 1 or greater and 3 or less.

It is desirable that Ar in Formula (7) is, for example, represented by Formula (8) or (9).

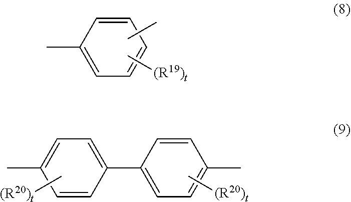

In Formulae (8) and (9), R¹⁹ and R²⁰ each independently represent one selected from the group consisting of a hydrogen atom, an alkyl group having 1 or more and 4 or less carbon atoms, an alkoxy group having 1 or more and 4 or less carbon atoms, a phenyl group substituted with an alkoxy group having 1 or more and 4 or less carbon atoms, an unsubstituted phenyl group, an aralkyl group having 7 or more and 10 or less carbon atoms, and a halogen atom, and t represents an integer of 1 or greater and 3 or less.

It is desirable that Z′ in Formula (7) is, for example, represented by any of Formulae (10) to (17).

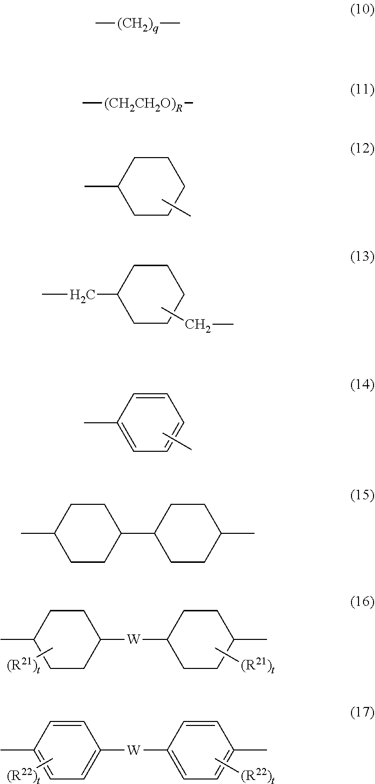

In Formulae (10) to (17), R²¹ and R²² each independently represent one selected from the group consisting of a hydrogen atom, an alkyl group having 1 or more and 4 or less carbon atoms, a phenyl group substituted with an alkyl group having 1 or more and 4 or less carbon atoms or an alkoxy group having 1 or more and 4 or less carbon atoms, an unsubstituted phenyl group, an aralkyl group having 7 or more and 10 or less carbon atoms, and a halogen atom, W represents a divalent group, q and r each independently represent an integer of 1 or greater and 10 or less, and t's each independently represent an integer of 1 or greater and 3 or less.

It is desirable that W in Formulae (16) and (17) is, for example, represented by any of the divalent groups represented by Formulae (18) to (26). Here, in Formula (25), u represents an integer of 0 or greater and 3 or less.

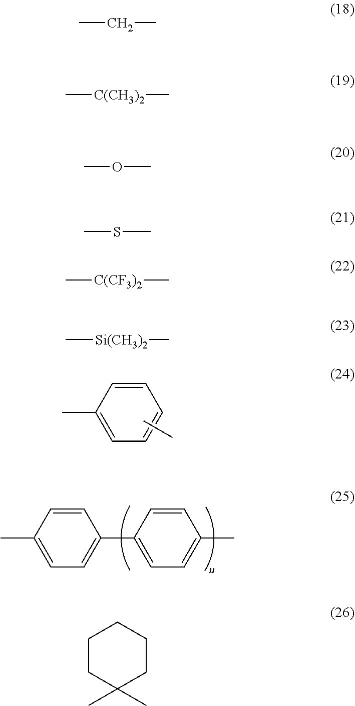

In General Formula (II), Ar⁵ represents an aryl group of Formulae (1) to (7) described in the section of Ar¹ to Ar⁴ in a case where k represents 0 and represents an arylene group obtained by removing a hydrogen atom from the aryl group of Formulae (1) to (7) in a case where k represents 1.

Specific examples of the compound represented by General Formula (I) are shown below, but the compound represented by General Formula (I) is not limited thereto.

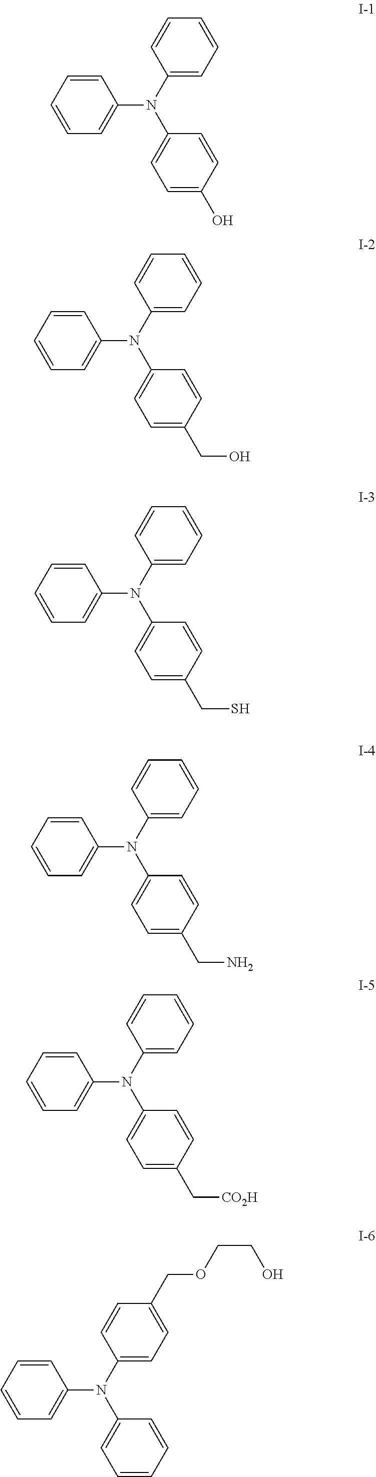

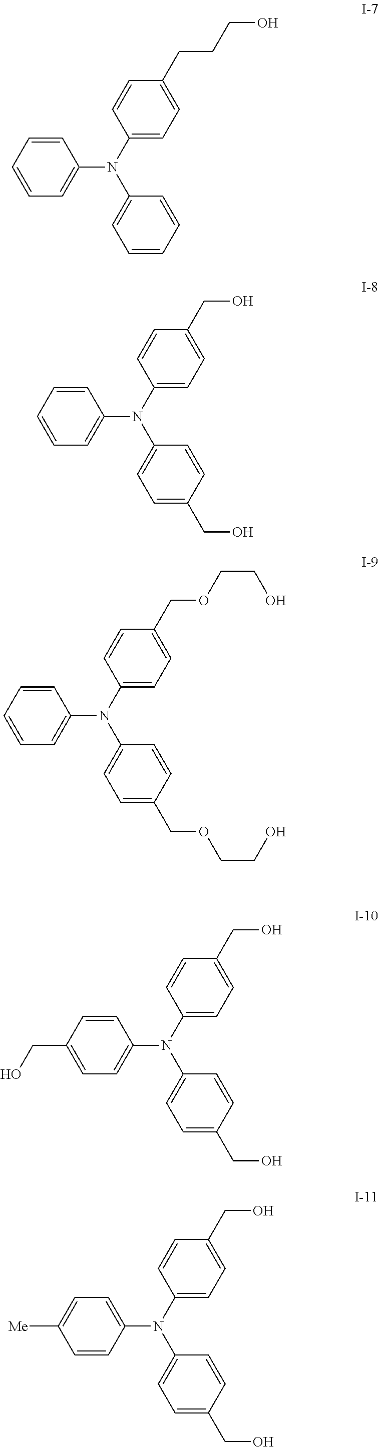

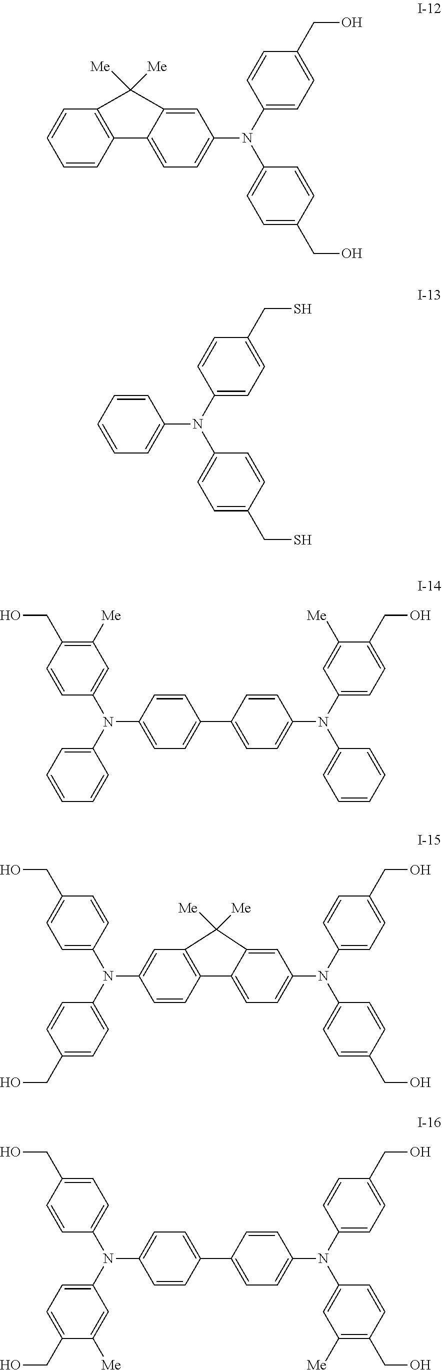

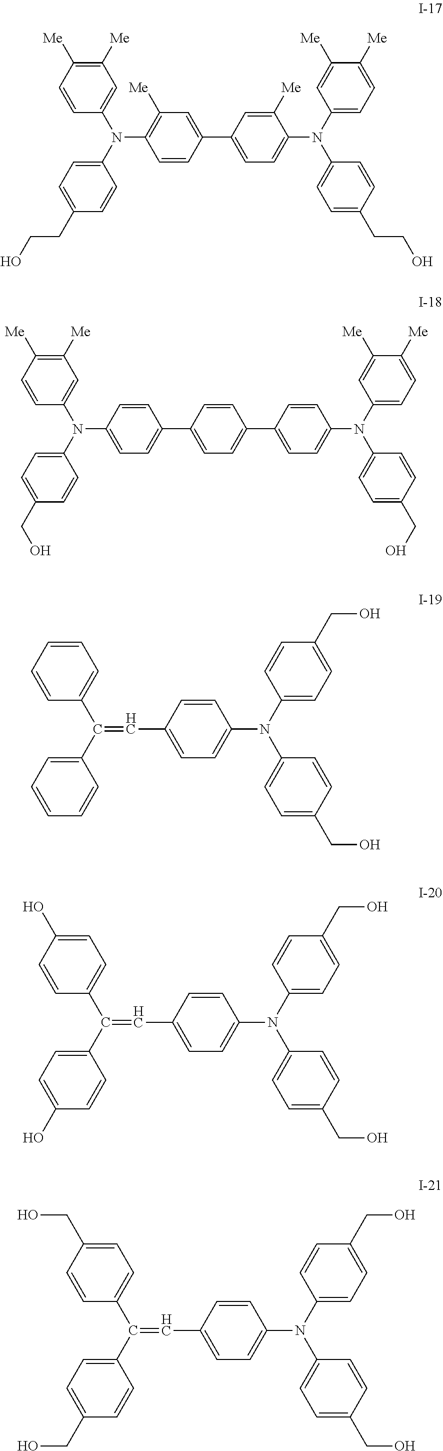

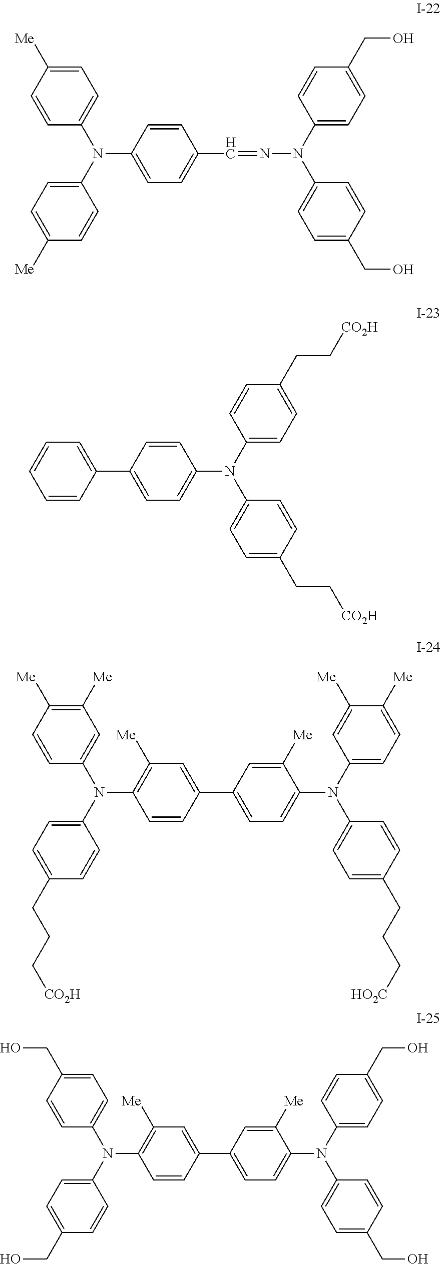

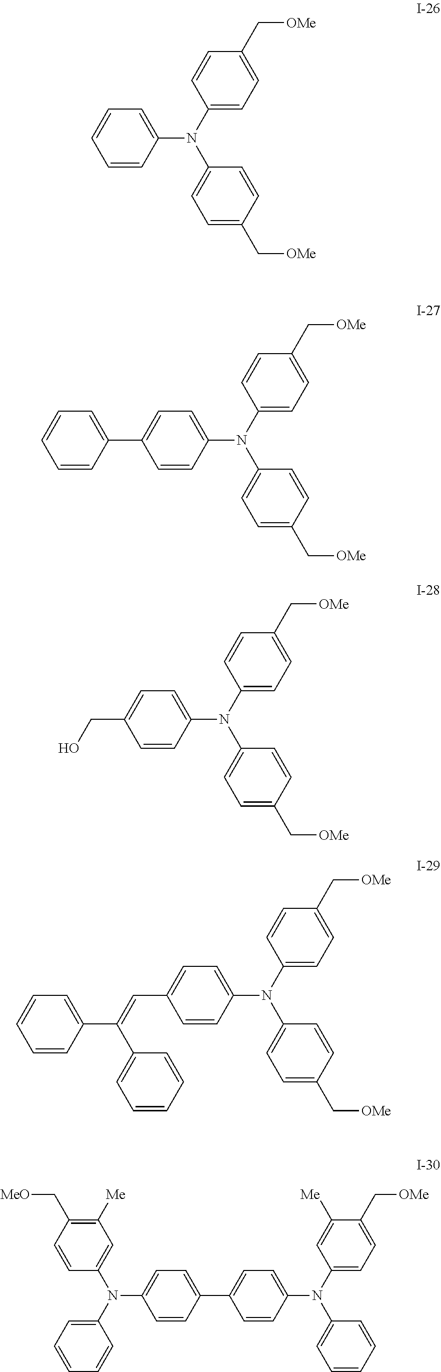

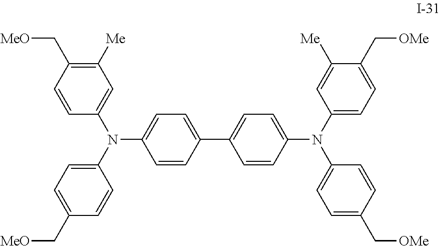

The total content (solid content concentration in the coating solution) of the specific charge transport material is, for example, preferably 90% by mass or greater and more preferably 94% by mass or greater. In a case where the solid content concentration thereof is 90% by mass or greater, a decrease in electrical properties is reduced.

### Curing Agent

The surface protective layer may be a layer formed of a cured film with a composition further containing a curing agent in addition to the resin (X) and the reactive group-containing charge transport material. The curing agent may be used alone or in combination of two or more kinds thereof.

Examples of the curing agent include an isocyanate compound, a polyol, a guanamine compound, and a melamine compound. Among these, it is preferable that the composition contains, for example, at least one compound selected from a compound having a guanamine structure (hereinafter, also referred to as “guanamine compound”) or a compound having a melamine structure (hereinafter, also referred to as “melamine compound”) as a curing agent.

In the cured film formed of a composition containing at least one compound selected from a guanamine compound or a melamine compound as a curing agent, residual OH, water, or the like is difficult to generate in the film, and the formation of the coating film is unlikely to be affected by the moisture in the atmosphere. Therefore, in a case of the cured film having a composition containing these compounds, the coating film defects are more suppressed in the formation of the surface protective layer, and the streak-like image defects are also further suppressed. Further, a cured film having a high curing degree is likely to be obtained, and the abrasion resistance is more excellent.

In particular, it is preferable that the surface protective layer contains, for example, the resin (X), at least one curing agent of a guanamine compound or a melamine compound, and at least one reactive group-containing charge transport material (hereinafter, also referred to as “specific charge transport material”) having at least one substituent selected from the group consisting of —OH, —OCH₃, —NH₂, —SH, and —COOH.

In the cured film formed of a composition containing the resin (X), at least one curing agent of a guanamine compound or a melamine compound, and the specific charge transport material, residual OH, water, or the like is difficult to generate in the film, and the formation of the coating film is unlikely to be affected by the moisture in the atmosphere. Therefore, in a case of the cured film having a composition containing these compounds, the coating film defects are more suppressed in the formation of the surface protective layer, and the streak-like image defects are also further suppressed.

### Guanamine Compound

The guanamine compound is a compound having a guanamine skeleton (structure), and examples thereof include acetoguanamine, benzoguanamine, formoguanamine, steroguanamine, spiroguanamin, and cyclohexylguanamine.

It is desirable that the composition contains, for example, at least one of a compound represented by General Formula (A) or a multimer thereof as the guanamine compound. Here, the multimer is an oligomer in which a compound represented by General Formula (A) is polymerized as a structural unit, and the polymerization degree thereof is, for example, 2 or greater and 200 or less (for example, preferably 2 or greater and 100 or less). Further, the compound represented by General Formula (A) may be used alone or in combination of two or more kinds thereof. In particular, in a case where two or more kinds of the compound represented by General Formula (A) are mixed and used or the compound is used as a multimer (oligomer) having the compound as a structural unit, the solubility in a solvent is improved.

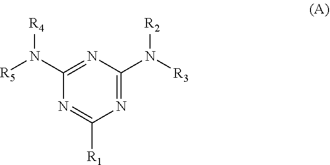

In General Formula (A), R₁ represents a linear or branched alkyl group having 1 or more and 10 or less carbon atoms, a substituted or unsubstituted phenyl group having 6 or more and 10 or less carbon atoms, or a substituted or unsubstituted alicyclic hydrocarbon group having 4 or more and 10 or less carbon atoms. R₂ to R₅ each independently represent a hydrogen atom, —CH₂—OH, or —CH₂—O—R₆. R₆ represents a linear or branched alkyl group having 1 or more and 10 or less carbon atoms.

In General Formula (A), the alkyl group represented by R₁ has 1 or more and 10 or less carbon atoms, for example, preferably 1 or more and 8 or less carbon atoms, and more preferably 1 or more and 5 or less carbon atoms. Further, the alkyl group may be linear or branched.

In General Formula (A), the phenyl group represented by R₁ has 6 or more and 10 or less carbon atoms and, for example, more preferably 6 or more and 8 or less carbon atoms. Examples of the substituent substituted with the phenyl group include a methyl group, an ethyl group, and a propyl group.

In General Formula (A), the alicyclic hydrocarbon group represented by R₁ has 4 or more and 10 or less carbon atoms and, for example, more preferably 5 or more and 8 or less carbon atoms. Examples of the substituent substituted with the alicyclic hydrocarbon group include a methyl group, an ethyl group, and a propyl group.

In “—CH₂—O—R₆” represented by R₂ to R₅ in General Formula (A), the alkyl group represented by R₆ has 1 or more and 10 or less carbon atoms, for example, preferably 1 or more and 8 or less carbon atoms, and more preferably 1 or more and 6 or less carbon atoms. Further, the alkyl group may be linear or branched. Preferred examples thereof include a methyl group, an ethyl group, and a butyl group.

It is particularly preferable that the compound represented by General Formula (A) is, for example, a compound in which R₁ represents a substituted or unsubstituted phenyl group having 6 or more and 10 or less carbon atoms and R₂ to R₅ each independently represent —CH₂—O—R₆. Further, it is desirable that R₆ represents, for example, a group selected from a methyl group or an n-butyl group.

The compound represented by General Formula (A) is synthesized, for example, by a known method using guanamine and formaldehyde (for example, edited by The Chemical Society of Japan, The fourth series of Experimental Chemistry, Vol. 28, p. 430).

Hereinafter, exemplary compounds (A)-1 to (A)-42 are shown as specific examples of the compound represented by General Formula (A), but the present exemplary embodiment is not limited thereto. Further, the following specific examples are monomers, but multimers (oligomers) having these monomers as structural units may be used. In the following exemplary compounds, “Me” represents a methyl group, “Bu” represents a butyl group, and “Ph” represents a phenyl group.

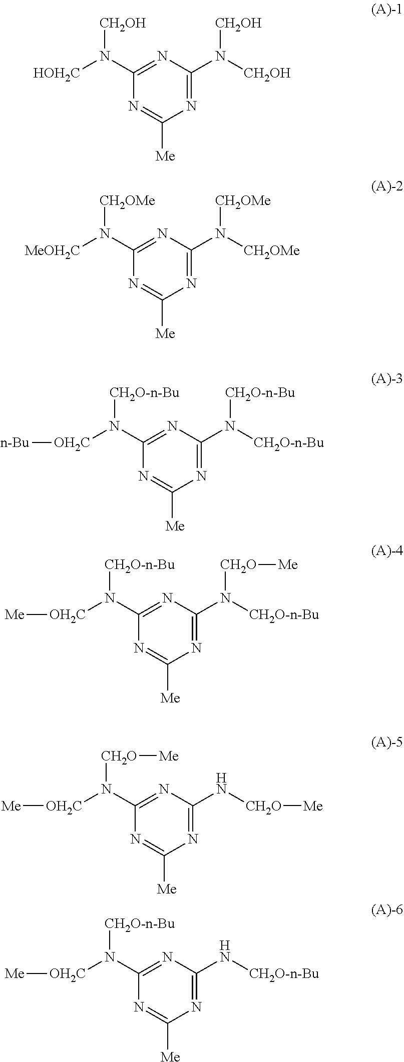

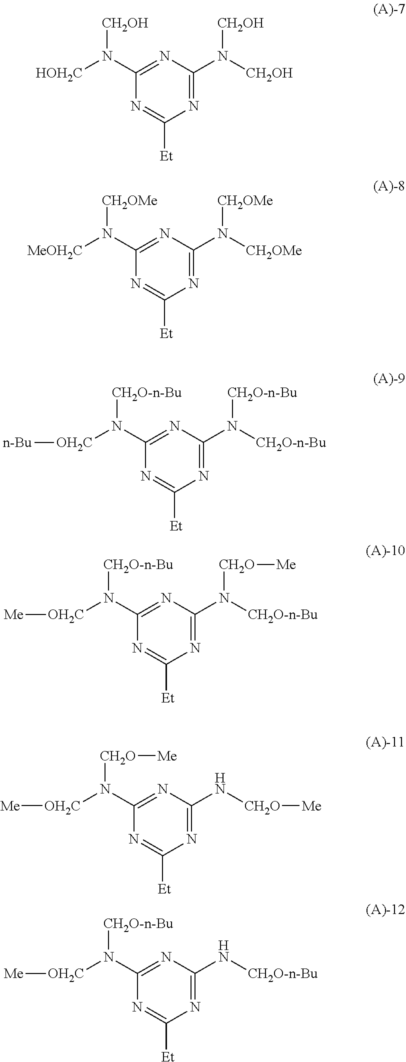

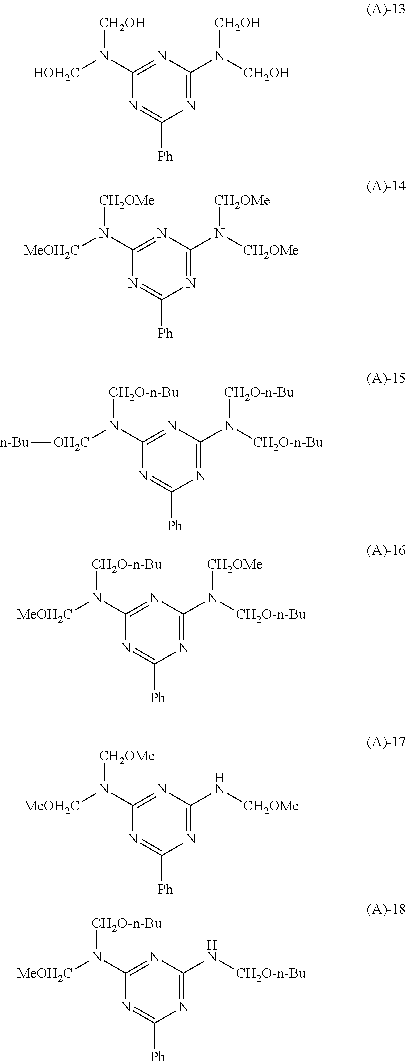

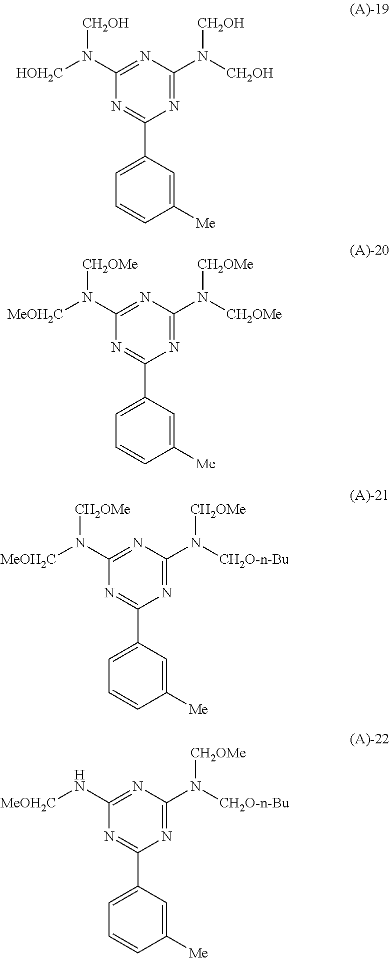

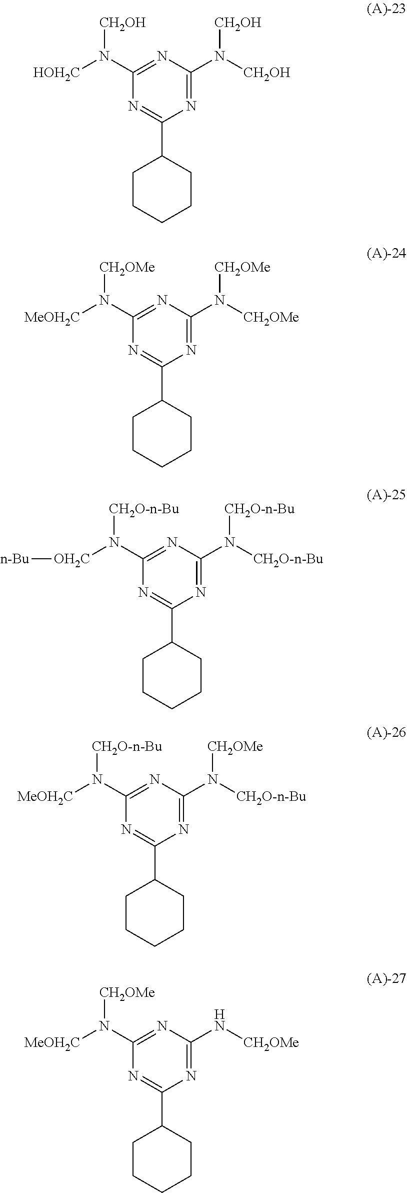

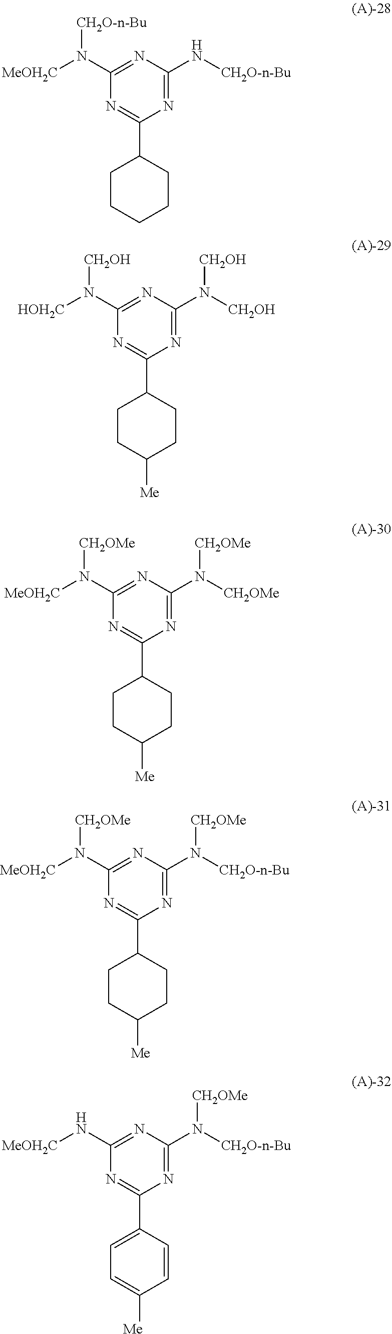

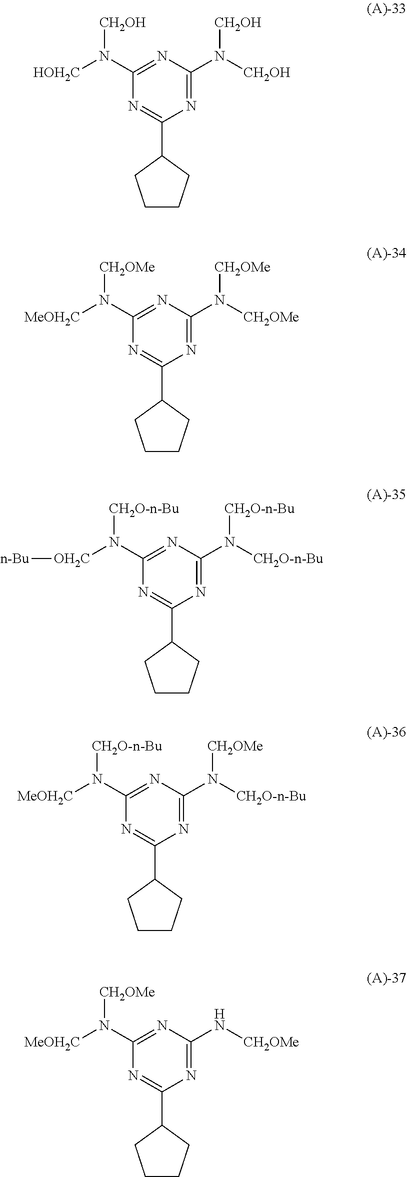

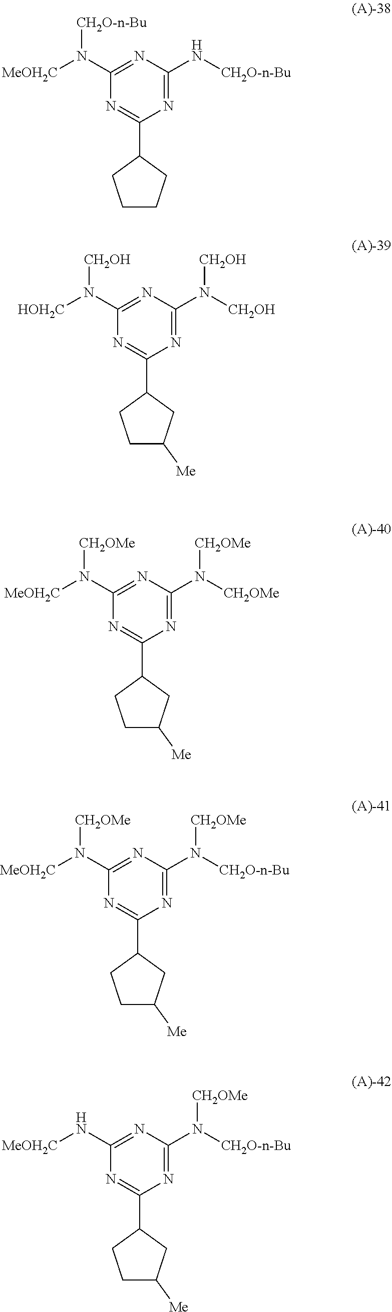

Examples of a commercially available product of the compound represented by General Formula (A) include SUPER BECKAMINE (R) L-148-55, SUPER BECKAMINE (R) 13-535, and SUPER BECKAMINE (R) L-145-60, and SUPER BECKAMINE (R) TD-126 (manufactured by DIC Corporation), and NIKALAC BL-60 and NIKALAC BX-4000 (manufactured by Nippon Carbide Industries Co., Inc.).

Further, the compound (including a multimer) represented by General Formula (A) may be dissolved in an appropriate solvent such as toluene, xylene, or ethyl acetate and washed with distilled water, ion exchange water, or the like, or treated with an ion exchange resin to be removed in order to eliminate the influence of a residual catalyst after synthesis or purchase of a commercially available product.

### Melamine Compound

It is desirable that the melamine compound is, for example, a melamine skeleton (structure) and is particularly at least one of a compound represented by General Formula (B) or a multimer thereof. Here, the multimer is an oligomer in which a compound represented by General Formula (B) is polymerized as a structural unit similar to General Formula (A), and the polymerization degree thereof is, for example, 2 or greater and 200 or less (for example, preferably 2 or greater and 100 or less). Further, the compound represented by General Formula (B) or the multimer thereof may be used alone or in combination of two or more kinds thereof. Further, the compound represented by General Formula (B) or the multimer thereof may be used in combination with the compound represented by General Formula (A) or the multimer thereof. In particular, in a case where two or more kinds of the compounds represented by General Formula (B) are mixed and used or the compound is used as a multimer (oligomer) having the compound as a structural unit, the solubility in a solvent is improved.

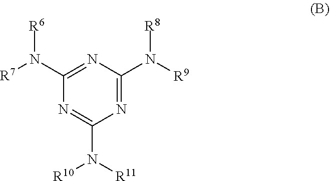

In General Formula (B), R⁶ to R¹¹ each independently represent a hydrogen atom, —CH₂—OH, —CH₂—O—R¹², or —O—R¹², and R¹² represents an alkyl group having 1 or more and 5 or less carbon atoms that may be branched. Examples of the alkyl group include a methyl group, an ethyl group, and a butyl group.

The compound represented by General Formula (B) is synthesized by a known method using, for example, melamine and formaldehyde (for example, synthesized in the same manner as the melamine resin in The fourth series of Experimental Chemistry, Vol. 28, p. 430).

Hereinafter, exemplary compounds (B)-1 to (B)-8 are shown as specific examples of the compound represented by General Formula (B), but the present exemplary embodiment is not limited thereto. Further, the following specific examples are monomers, but multimers (oligomers) having these monomers as structural units may be used.

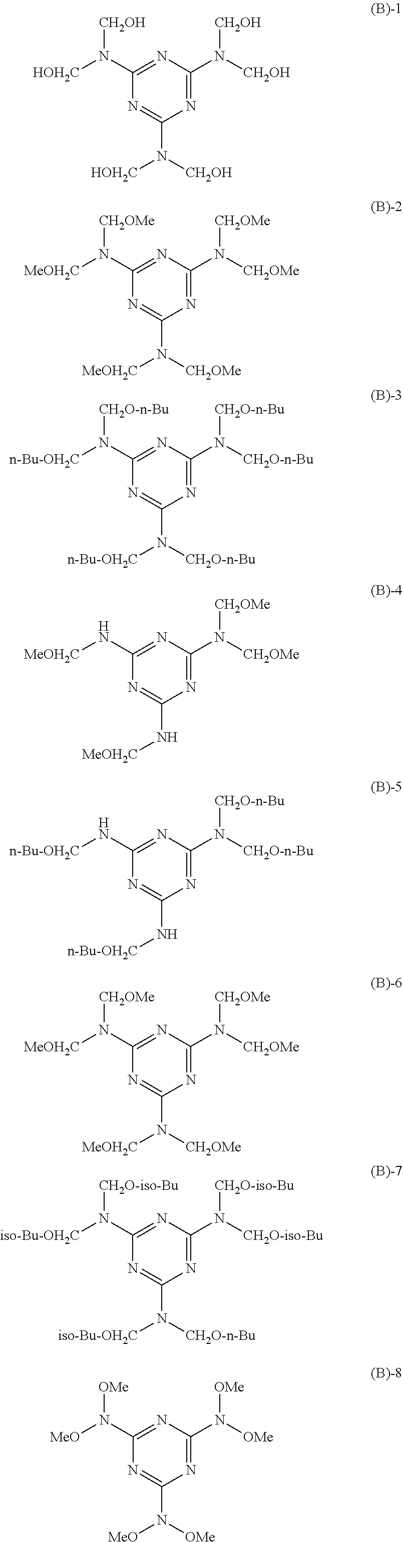

Examples of a commercially available product of the compound represented by General Formula (B) include SUPER MELAMI No. 90 (manufactured by NOF Corporation), SUPER BECKAMINE (R) TD-139-60 (manufactured by DIC Corporation), U-VAN 2020 (manufactured by Mitsui Chemicals, Inc.), SUMITEX RESIN M-3 (manufactured by Sumitomo Chemical Industry Co., Ltd.), and NIKALAC MW-30 (manufactured by Nippon Carbide Industries Co., Inc.).

Further, the compound (including a multimer) represented by General Formula (B) may be dissolved in an appropriate solvent such as toluene, xylene, or ethyl acetate and washed with distilled water, ion exchange water, or the like, or treated with an ion exchange resin for removal in order to eliminate the influence of a residual catalyst after synthesis or purchase of a commercially available product.

The proportion of the guanamine compound and the melamine compound in the total amount of the curing agent is, for example, preferably 80% by mass or greater, more preferably 85% by mass or greater and 100% by mass or less, and still more preferably 90% by mass or greater and 100% by mass or less.

The total content (solid content concentration in the coating solution) of the guanamine compound (for example, preferably the compound represented by General Formula (A)) and the melamine compound (for example, preferably the compound represented by General Formula (B)) is, for example, preferably 0.1% by mass or greater and 5% by mass or less and more preferably 1% by mass or greater and 3% by mass or less. In a case where the solid content concentration thereof is 0.1% by mass or greater, the film is likely to be dense, and the strength and the film forming properties tend to be further improved. In a case where the solid content concentration is 5% by mass or less, coating unevenness is suppressed during film formation, and the film forming properties are further improved. Further, degradation of electrical properties and ghost resistance (more specifically, density unevenness due to image history) is suppressed.

The surface protective layer may also contain other known additives.

The formation of the surface protective layer is not particularly limited, and a known forming method is used. For example, a coating film of a coating solution for forming a surface protective layer in which the above-described components are added to a solvent is formed, and the coating film is dried and, as necessary, subjected to a curing treatment such as heating.

Examples of the solvent for preparing the coating solution for forming a surface protective layer include an aromatic solvent such as toluene or xylene; a ketone-based solvent such as methyl ethyl ketone, methyl isobutyl ketone, or cyclohexanone; an ester-based solvent such as ethyl acetate or butyl acetate; an ether-based solvent such as tetrahydrofuran or dioxane; a cellosolve-based solvent such as ethylene glycol monomethyl ether; and an alcohol-based solvent such as isopropyl alcohol or butanol. These solvents are used alone or in the form of a mixture of two or more kinds thereof.

In addition, the coating solution for forming a surface protective layer may be a solvent-less coating solution.

Examples of the method of coating the photosensitive layer (such as the charge transport layer) with the coating solution for forming a surface protective layer include typical coating methods such as a dip coating method, a push-up coating method, a wire bar coating method, a spray coating method, a blade coating method, an air knife coating method, and a curtain coating method.

The film thickness of the surface protective layer is set to be, for example, preferably in a range of 1 μm or greater and 20 μm or less and more preferably in a range of 2 μm or greater and 10 μm or less.

### Conductive Substrate

Examples of the conductive substrate include metal plates containing metals (such as aluminum, copper, zinc, chromium, nickel, molybdenum, vanadium, indium, gold, and platinum) or alloys (such as stainless steel), metal drums, metal belts, and the like. Further, examples of the conductive substrate include paper, a resin film, a belt, and the like obtained by being coated, vapor-deposited or laminated with a conductive compound (such as a conductive polymer or indium oxide), a metal (such as aluminum, palladium, or gold) or an alloy. Here, the term “conductive” denotes that the volume resistivity is less than 1×10¹³ Ωcm.

In a case where the electrophotographic photoreceptor is used in a laser printer, for example, it is preferable that the surface of the conductive substrate is roughened such that a centerline average roughness Ra thereof is 0.04 μm or greater and 0.5 μm or less for the purpose of suppressing interference fringes from occurring in a case of irradiation with laser beams. In a case where incoherent light is used as a light source, roughening of the surface to prevent interference fringes is not particularly necessary, and it is appropriate for longer life because occurrence of defects due to the unevenness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment performed by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by anodization is chemically active in a natural state, is easily contaminated, and has a large resistance fluctuation depending on the environment. Therefore, for example, it is preferable that a sealing treatment is performed on the porous anodized film so that the fine pores of the oxide film are closed by volume expansion due to a hydration reaction in pressurized steam or boiling water (a metal salt such as nickel may be added thereto) for a change into a more stable a hydrous oxide.

The film thickness of the anodized film is, for example, preferably 0.3 μm or greater and 15 μm or less. In a case where the film thickness is in the above-described range, the barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. In the blending ratio of phosphoric acid, chromic acid, and hydrofluoric acid to the acidic treatment liquid, for example, the concentration of the phosphoric acid is 10% by mass or greater and 11% by mass or less, the concentration of the chromic acid is 3% by mass or greater and 5% by mass or less, and the concentration of the hydrofluoric acid is 0.5% by mass or greater and 2% by mass or less, and the concentration of all these acids may be 13.5% by mass or greater and 18% by mass or less. The treatment temperature is, for example, preferably 42° C. or higher and 48° C. or lower. The film thickness of the coating film is, for example, preferably 0.3 μm or greater and 15 μm or less.

The boehmite treatment is carried out, for example, by immersing the conductive substrate in pure water at 90° C. or higher and 100° C. or lower for 5 minutes to 60 minutes or by bringing the conductive substrate into contact with heated steam at 90° C. or higher and 120° C. or lower for 5 minutes to 60 minutes. The film thickness of the coating film is, for example, preferably 0.1 μm or greater and 5 μm or less. This coating film may be further subjected to the anodizing treatment using an electrolytic solution having low film solubility, such as adipic acid, boric acid, a borate, a phosphate, a phthalate, a maleate, a benzoate, a tartrate, or a citrate.

### Undercoat Layer

The undercoat layer is, for example, a layer containing inorganic particles and a binder resin.

Examples of the inorganic particles include inorganic particles having a powder resistance (volume resistivity) of 1×10² Ωcm or greater and 1×10¹¹ Ωcm or less.

Among these, as the inorganic particles having the above-described resistance value, for example, metal oxide particles such as tin oxide particles, titanium oxide particles, zinc oxide particles, and zirconium oxide particles may be used, and zinc oxide particles are particularly preferable.

The specific surface area of the inorganic particles measured by the BET method may be, for example, 10 m²/g or greater.

The volume average particle diameter of the inorganic particles may be, for example, 50 nm or greater and 2,000 nm or less (for example, preferably 60 nm or greater and 1,000 nm or less).

The content of the inorganic particles is, for example, preferably 10% by mass or greater and 80% by mass or less and more preferably 40% by mass or greater and 80% by mass or less with respect to the amount of the binder resin.

The inorganic particles may be subjected to a surface treatment. As the inorganic particles, inorganic particles subjected to different surface treatments or inorganic particles having different particle diameters may be used in the form of a mixture of two or more kinds thereof.

Examples of the surface treatment agent include a silane coupling agent, a titanate-based coupling agent, an aluminum-based coupling agent, and a surfactant. In particular, for example, a silane coupling agent is preferable, and a silane coupling agent containing an amino group is more preferable.

Examples of the silane coupling agent containing an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

The silane coupling agent may be used in the form of a mixture of two or more kinds thereof. For example, a silane coupling agent containing an amino group and another silane coupling agent may be used in combination. Examples of other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but are not limited thereto.

The surface treatment method using a surface treatment agent may be any method as long as the method is a known method, and any of a dry method or a wet method may be used.

The treatment amount of the surface treatment agent is, for example, preferably 0.5% by mass or greater and 10% by mass or less with respect to the amount of the inorganic particles.

The undercoat layer may contain an electron-accepting compound (acceptor compound) together with the inorganic particles from the viewpoint of enhancing the long-term stability of the electrical properties and the carrier blocking properties.

Examples of the electron-accepting compound include electron-transporting substances, for example, a quinone-based compound such as chloranil or bromanil; a tetracyanoquinodimethane-based compound; a fluorenone compound such as 2,4,7-trinitrofluorenone or 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, or 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable, and specifically, for example, anthraquinone, alizarin, quinizarin, anthrarufin, or purpurin is preferable.

The electron-accepting compound may be contained in the undercoat layer in a state of being dispersed with inorganic particles or in a state of being attached to the surface of each inorganic particle.

Examples of the method of attaching the electron-accepting compound to the surface of the inorganic particle include a dry method and a wet method.

The dry method is, for example, a method of attaching the electron-accepting compound to the surface of each inorganic particle by adding the electron-accepting compound dropwise to inorganic particles directly or by dissolving the electron-accepting compound in an organic solvent while stirring the inorganic particles with a mixer having a large shearing force and spraying the mixture together with dry air or nitrogen gas. The electron-accepting compound may be added dropwise or sprayed, for example, at a temperature lower than or equal to the boiling point of the solvent. After the dropwise addition or the spraying of the electron-accepting compound, the compound may be further baked at 100° C. or higher. The baking is not particularly limited as long as the temperature and the time are adjusted such that the electrophotographic characteristics can be obtained.

The wet method is, for example, a method of attaching the electron-accepting compound to the surface of each inorganic particle by adding the electron-accepting compound to inorganic particles while dispersing the inorganic particles in a solvent using a stirrer, ultrasonic waves, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that the electrophotographic characteristics can be obtained. In the wet method, the moisture contained in the inorganic particles may be removed before the electron-accepting compound is added, and examples thereof include a method of removing the moisture while stirring and heating the moisture in a solvent and a method of removing the moisture by azeotropically boiling the moisture with a solvent.

The electron-accepting compound may be attached to the surface before or after the inorganic particles are subjected to a surface treatment with a surface treatment agent or simultaneously with the surface treatment performed on the inorganic particles with a surface treatment agent.

The content of the electron-accepting compound may be, for example, 0.01% by mass or greater and 20% by mass or less and preferably 0.01% by mass or greater and 10% by mass or less with respect to the amount of the inorganic particles.

Examples of the binder resin used for the undercoat layer include known polymer compounds such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, a urethane resin, an alkyd resin, and an epoxy resin, a zirconium chelate compound, a titanium chelate compound, an aluminum chelate compound, a titanium alkoxide compound, an organic titanium compound, and known materials such as a silane coupling agent.

Examples of the binder resin used for the undercoat layer include a charge-transporting resin containing a charge-transporting group, and a conductive resin (such as polyaniline).

Among these, as the binder resin used for the undercoat layer, for example, a resin insoluble in a coating solvent of the upper layer is preferable, and a resin obtained by reaction between a curing agent and at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin is particularly preferable.

In a case where these binder resins are used in combination of two or more kinds thereof, the mixing ratio thereof is set as necessary.

The undercoat layer may contain various additives for improving the electrical properties, the environmental stability, and the image quality.

Examples of the additives include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for a surface treatment of the inorganic particles as described above, but may be further added to the undercoat layer as an additive.

Examples of the silane coupling agent serving as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in the form of a mixture or a polycondensate of a plurality of compounds.

The undercoat layer may have, for example, a Vickers hardness of 35 or greater.

The surface roughness (ten-point average roughness) of the undercoat layer may be adjusted, for example, to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. Further, the surface of the undercoat layer may be polished to adjust the surface roughness. Examples of the polishing method include buff polishing, a sandblast treatment, wet honing, and a grinding treatment.

The formation of the undercoat layer is not particularly limited, and a known forming method is used. For example, a coating film of a coating solution for forming an undercoat layer in which the above-described components are added to a solvent is formed, and the coating film is dried and, as necessary, heated.

Examples of the solvent for preparing the coating solution for forming an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of these solvents include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming an undercoat layer include known methods such as a roll mill, a ball mill, a vibration ball mill, an attritor, a sand mill, a colloid mill, and a paint shaker.

Examples of the method of coating the conductive substrate with the coating solution for forming an undercoat layer include typical coating methods such as a blade coating method, a wire bar coating method, a spray coating method, a dip coating method, a bead coating method, an air knife coating method, and a curtain coating method.

The average thickness of the undercoat layer is, for example, preferably 10 μm or greater and 50 μm or less and more preferably 15 μm or greater and 40 μm or less.

### Interlayer

An interlayer may be further provided between the undercoat layer and the photosensitive layer.

The interlayer is, for example, a layer containing a resin. Examples of the resin used for the interlayer include a polymer compound, for example, an acetal resin (such as polyvinyl butyral), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, or a melamine resin.

The interlayer may be a layer containing an organometallic compound. Examples of the organometallic compound used for the interlayer include an organometallic compound containing metal atoms such as zirconium, titanium, aluminum, manganese, and silicon.

The compounds used for the interlayer may be used alone or in the form of a mixture or a polycondensate of a plurality of compounds.

Among these, it is preferable that the interlayer is, for example, a layer containing an organometallic compound having a zirconium atom or a silicon atom.

The formation of the interlayer is not particularly limited, and a known forming method is used. For example, a coating film of a coating solution for forming an interlayer in which the above-described components are added to a solvent is formed, and the coating film is dried and, as necessary, heated.

Examples of the coating method of forming the interlayer include typical coating methods such as a dip coating method, a push-up coating method, a wire bar coating method, a spray coating method, a blade coating method, an air knife coating method, and a curtain coating method.

The average thickness of the interlayer is, for example, preferably 0.1 μm or greater and 3 μm or less. The interlayer may be used as the undercoat layer.

### Charge Generation Layer

The charge generation layer is, for example, a layer containing a charge generation material and a binder resin. Further, the charge generation layer may be a deposition layer of the charge generation material. The deposition layer of the charge generation material is, for example, appropriate in a case where an incoherent light source such as a light emitting diode (LED) or an organic electro-luminescence (EL) image array is used.

Examples of the charge generation material include an azo pigment such as bisazo or trisazo; a fused ring aromatic pigment such as dibromoanthanthrone; a perylene pigment; a pyrrolopyrrole pigment; a phthalocyanine pigment; zinc oxide; and trigonal selenium.

Among these, for example, a metal phthalocyanine pigment or a metal-free phthalocyanine pigment is preferably used as the charge generation material in order to deal with laser exposure in a near infrared region. Specifically, for example, hydroxygallium phthalocyanine, chlorogallium phthalocyanine, dichloro-tin phthalocyanine, and titanyl phthalocyanine are more preferable.

On the other hand, for example, a fused ring aromatic pigment such as dibromoanthanthrone, a thioindigo-based pigment, a porphyrazine compound, zinc oxide, trigonal selenium, or a bisazo pigment is preferable as the charge generation material in order to deal with laser exposure in a near ultraviolet region.

The above-described charge generation material may also be used even in a case where an incoherent light source such as an LED or an organic EL image array having a center wavelength of light emission at 450 nm or greater and 780 nm or less is used, but from the viewpoint of the resolution, the field intensity in the photosensitive layer is increased, and a decrease in charge due to injection of a charge from the substrate, that is, image defects referred to as so-called black spots are likely to occur in a case where a thin film having a thickness of 20 μm or less is used as the photosensitive layer. The above-described tendency is evident in a case where a p-type semiconductor such as trigonal selenium or a phthalocyanine pigment is used as the charge generation material that is likely to generate a dark current.

On the other hand, in a case where an n-type semiconductor such as a fused ring aromatic pigment, a perylene pigment, or an azo pigment is used as the charge generation material, a dark current is unlikely to be generated, and image defects referred to as black spots can be suppressed even in a case where a thin film is used as the photosensitive layer. The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (a polycondensate of bisphenols and aromatic divalent carboxylic acid), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” denotes that the volume resistivity is 1×10¹³ Ωcm or greater.

These binder resins may be used alone or in the form of a mixture of two or more kinds thereof.

The blending ratio between the charge generation material and the binder resin is, for example, preferably in a range of 10:1 to 1:10 in terms of the mass ratio.

The charge generation layer may also contain other known additives.

The formation of the charge generation layer is not particularly limited, and a known forming method is used. For example, a coating film of a coating solution for forming a charge generation layer in which the above-described components are added to a solvent is formed, and the coating film is dried and, as necessary, heated. The charge generation layer may be formed by vapor deposition of the charge generation material. The formation of the charge generation layer by vapor deposition is, for example, particularly appropriate in a case where a fused ring aromatic pigment or a perylene pigment is used as the charge generation material.

Examples of the solvent for preparing the coating solution for forming a charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in the form of a mixture of two or more kinds thereof.

As a method of dispersing particles (for example, the charge generation material) in the coating solution for forming a charge generation layer, for example, a media disperser such as a ball mill, a vibration ball mill, an attritor, a sand mill, or a horizontal sand mill, or a medialess disperser such as a stirrer, an ultrasonic disperser, a roll mill, or a high-pressure homogenizer is used. Examples of the high-pressure homogenizer include a collision type homogenizer in which a dispersion liquid is dispersed by a liquid-liquid collision or a liquid-wall collision in a high-pressure state, and a penetration type homogenizer in which a dispersion liquid is dispersed by penetrating the liquid through a fine flow path in a high-pressure state.

During the dispersion, it is effective to set the average particle diameter of the charge generation material in the coating solution for forming a charge generation layer to 0.5 μm or less, for example, preferably 0.3 μm or less, and more preferably 0.15 μm or less.

Examples of the method of coating the undercoat layer (or the interlayer) with the coating solution for forming a charge generation layer include typical methods such as a blade coating method, a wire bar coating method, a spray coating method, a dip coating method, a bead coating method, an air knife coating method, and a curtain coating method.

The average thickness of the charge generation layer is, for example, preferably 0.1 μm or greater and 5.0 μm or less and more preferably 0.2 μm or greater and 2.0 μm or less.

### Charge Transport Layer

The charge transport layer is, for example, a layer containing a charge transport material and a binder resin. The charge transport layer may be a layer containing a polymer charge transport material.

Examples of the charge transport material include a quinone-based compound such as p-benzoquinone, chloranil, bromanil, or anthraquinone; a tetracyanoquinodimethane-based compound; a fluorenone compound such as 2,4,7-trinitrofluorenone; a xanthone compound; a benzophenone-based compound; a cyanovinyl-based compound; and an electron-transporting compound such as an ethylene-based compound. Examples of the charge transport material include a positive hole-transporting compound such as a triarylamine-based compound, a benzidine-based compound, an arylalkane-based compound, an aryl-substituted ethylene-based compound, a stilbene-based compound, an anthracene-based compound, or a hydrazone-based compound. These charge transport materials may be used alone or in combination of two or more kinds thereof, but are not limited thereto.

From the viewpoint of the charge mobility, for example, a triarylamine derivative represented by Structural Formula (a-1) or a benzidine derivative represented by Structural Formula (a-2) is preferable as the charge transport material.

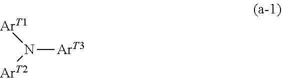

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

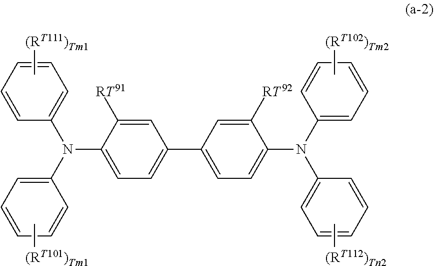

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, a substituted amino group substituted with an alkyl group having 1 or more and 2 or less carbon atoms, a substituted or unsubstituted aryl group, —C(R^{T12})═C(R^{T13})(R^{T14}), or —CH═CH—CH═C(R^{T15})(R^{T16}), and R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or greater and 2 or less.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

Here, among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” and a benzidine derivative having “—CH═CH—CH═C(R^{T15})(R^{T16})” are particularly preferable from the viewpoint of the charge mobility.

As the polymer charge transport material, known materials having charge transport properties, such as poly-N-vinylcarbazole and polysilane, can be used. Particularly, for example, a polyester-based polymer charge transport material is particularly preferable. Further, the polymer charge transport material may be used alone or in combination of binder resins.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among these, for example, a polycarbonate resin or a polyarylate resin is preferable as the binder resin. These binder resins may be used alone or in combination of two or more kinds thereof.

Further, the blending ratio between the charge transport material and the binder resin is, for example, preferably in a range of 10:1 to 1:5 in terms of the mass ratio.

The charge transport layer may also contain other known additives.

The formation of the charge transport layer is not particularly limited, and a known forming method is used. For example, a coating film of a coating solution for forming a charge transport layer in which the above-described components are added to a solvent is formed, and the coating film is dried and, as necessary, heated.

Examples of the solvent for preparing the coating solution for forming a charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in the form of a mixture of two or more kinds thereof.

Examples of the coating method of coating the charge generation layer with the coating solution for forming a charge transport layer include typical methods such as a blade coating method, a wire bar coating method, a spray coating method, a dip coating method, a bead coating method, an air knife coating method, and a curtain coating method.

The film thickness of the charge transport layer is set to be, for example, preferably in a range of 5 μm or greater and 50 μm or less and more preferably in a range of 10 μm or greater and 30 μm or less.

### Image Forming Apparatus and Process Cartridge

An image forming apparatus according to the present exemplary embodiment includes the electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, and a transfer device that transfers the toner image to a surface of a recording medium. Further, the electrophotographic photoreceptor according to the present exemplary embodiment is employed as the electrophotographic photoreceptor.

As the image forming apparatus according to the present exemplary embodiment, a known image forming apparatus such as an apparatus including a fixing device that fixes the toner image transferred to the surface of a recording medium; a direct transfer type apparatus that transfers the toner image formed on the surface of the electrophotographic photoreceptor directly to the recording medium; an intermediate transfer type apparatus that primarily transfers the toner image formed on the surface of the electrophotographic photoreceptor to the surface of the intermediate transfer member and secondarily transfers the toner image transferred to the surface of the intermediate transfer member to the surface of the recording medium; an apparatus including a cleaning device that cleans the surface of the electrophotographic photoreceptor after the transfer of the toner image and before the charging; an apparatus including a destaticizing device that destaticizes the surface of the electrophotographic photoreceptor by irradiating the surface with destaticizing light after the transfer of the toner image and before the charging; or an apparatus including an electrophotographic photoreceptor heating member for increasing the temperature of the electrophotographic photoreceptor and decreasing the relative temperature is employed.

In a case of the intermediate transfer type apparatus, the transfer unit is, for example, configured to include an intermediate transfer member having a surface onto which the toner image is transferred, a primary transfer device primarily transferring the toner image formed on the surface of the electrophotographic photoreceptor to the surface of the intermediate transfer member, and a secondary transfer device secondarily transferring the toner image transferred to the surface of the intermediate transfer member to the surface of the recording medium.

The image forming apparatus according to the present exemplary embodiment may be any of a dry development type image forming apparatus or a wet development type (development type using a liquid developer) image forming apparatus.

In the image forming apparatus according to the present exemplary embodiment, for example, the portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging device, an electrostatic latent image forming device, a developing device, and a transfer device in addition to the electrophotographic photoreceptor.

Hereinafter, an example of the image forming apparatus according to the present exemplary embodiment will be described, but the present exemplary embodiment is not limited thereto. Further, main parts shown in the figures will be described, but description of other parts will not be provided.

FIG. 2 is a schematic configuration view showing an example of the image forming apparatus according to the present exemplary embodiment.

As shown in FIG. 2, an image forming apparatus 100 according to the present exemplary embodiment includes a process cartridge 300 including an electrophotographic photoreceptor 7, an exposure device 9 (an example of an electrostatic latent image forming device), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300, the transfer device 40 is disposed at a position that faces the electrophotographic photoreceptor 7 via the intermediate transfer member 50, and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

The process cartridge 300 in FIG. 2 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade (an example of the cleaning member) 131, and the cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 2 shows an example of an image forming apparatus including a fibrous member 132 (roll shape) that supplies a lubricant 14 to the surface of the electrophotographic photoreceptor 7 and a fibrous member 133 (flat brush shape) that assists cleaning, but these are disposed as necessary.

Hereinafter, each configuration of the image forming apparatus according to the present exemplary embodiment will be described.

### Charging Device

As the charging device 8, for example, a contact-type charger formed of a conductive or semi-conductive charging roller, a charging brush, a charging film, a charging rubber blade, a charging tube, or the like is used. Further, a known charger such as a non-contact type roller charger, or a scorotron charger or a corotron charger using corona discharge is also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. The wavelength of the light source is within the spectral sensitivity region of the electrophotographic photoreceptor. As the wavelength of a semiconductor laser, near infrared, which has an oscillation wavelength in the vicinity of 780 nm, is mostly used. However, the wavelength is not limited thereto, and a laser having an oscillation wavelength of approximately 600 nm or a laser having an oscillation wavelength of 400 nm or greater and 450 nm or less as a blue laser may also be used. Further, a surface emission type laser light source capable of outputting a multi-beam is also effective for forming a color image.

### Developing Device

Examples of the developing device 11 include a typical developing device that performs development in contact or non-contact with the developer. The developing device 11 is not particularly limited as long as the developing device has the above-described functions, and is selected depending on the purpose thereof. Examples of the developing device include known developing machines having a function of attaching a one-component developer or a two-component developer to the electrophotographic photoreceptor 7 using a brush, a roller, or the like. Among these, for example, a developing device formed of a developing roller having a surface on which a developer is held is preferably used.

The developer used in the developing device 11 may be a one-component developer containing only a toner or a two-component developer containing a toner and a carrier. Further, the developer may be magnetic or non-magnetic. Known developers are employed as these developers.

### Cleaning Device

As the cleaning device 13, a cleaning blade type device including the cleaning blade 131 is used. In addition to the cleaning blade type device, a fur brush cleaning type device or a simultaneous development cleaning type device may be employed.

### Transfer Device

Examples of the transfer device 40 include a known transfer charger such as a contact-type transfer charger using a belt, a roller, a film, or a rubber blade, a scorotron transfer charger, or a corotron transfer charger using corona discharge.

### Intermediate Transfer Member

As the intermediate transfer member 50, a belt-like intermediate transfer member (intermediate transfer belt) containing semi-conductive polyimide, polyamide-imide, polycarbonate, polyarylate, polyester, rubber, or the like is used. Further, as the form of the intermediate transfer member, a drum-like intermediate transfer member may be used in addition to the belt-like intermediate transfer member.

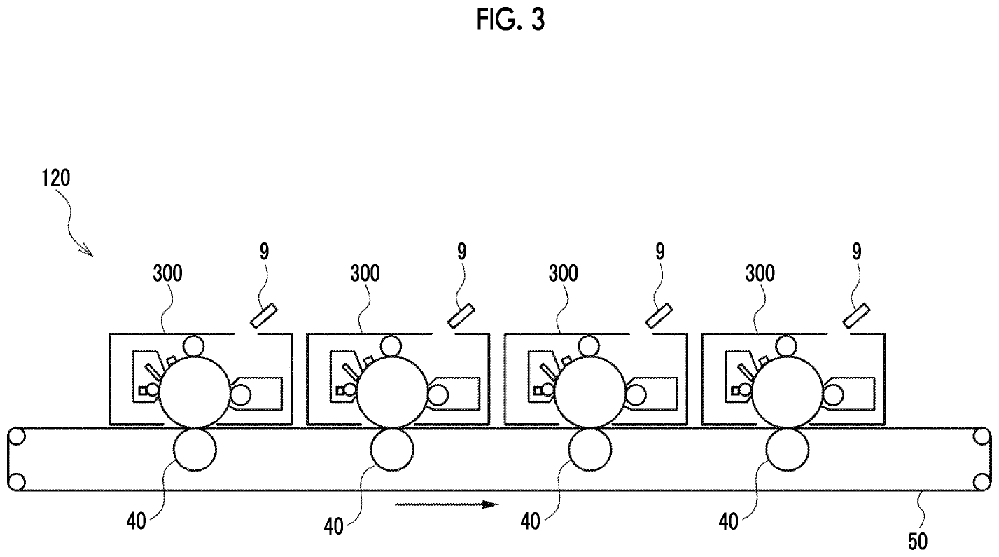

FIG. 3 is a schematic configuration view showing another example of the image forming apparatus according to the present exemplary embodiment.

An image forming apparatus 120 shown in FIG. 3 is a tandem type multicolor image forming apparatus on which four process cartridges 300 are mounted. The image forming apparatus 120 is formed such that four process cartridges 300 are arranged in parallel on the intermediate transfer member 50, and one electrophotographic photoreceptor is used for each color. The image forming apparatus 120 has the same configuration as the image forming apparatus 100 except that the image forming apparatus 120 is of a tandem type.

### EXAMPLES

Hereinafter, exemplary embodiments of the invention will be described in detail based on examples, but the exemplary embodiments of the invention are not limited to the examples.

In the following description, “parts” and “%” are on a mass basis unless otherwise specified.

In the following description, the synthesis, the treatment, the production, and the like are carried out at room temperature (25° C.±3° C.) unless otherwise specified.

### Synthesis of Resin X-A

20 parts by mass of xylene is added to a 200 ml three-neck flask and heated and stirred at 110° C. Next, a mixed solution of a monomer having a unit represented by Formula (X1), a monomer having a unit represented by Formula (X2), and a unit represented by Formula (X3) of the kind and the amount listed in Table 1, 10 parts by mass of butyl acetate, and 1 part by mass of a polymerization catalyst t-butylperoxy-2-ethylhexanoate is slowly added dropwise to the flask at 110° C. over 2 hours in a nitrogen atmosphere. Thereafter, the solution is allowed to react at 120° C. for 2 hours and copolymerization, thereby obtaining a resin.

### Synthesis of Resin X-B

A resin is obtained in the same manner as in the synthesis of the resin X-A except that the temperature of the dropwise addition is changed to 120° C.

### Synthesis of Resins X-C

A resin is obtained in the same manner as in the synthesis of the resin X-A except that the temperature of the dropwise addition is changed to 90° C.

### Synthesis of Resins X-D

A resin is obtained in the same manner as in the synthesis of the resin X-A except that the kinds and the amounts of the monomer having a unit represented by Formula (X1), the monomer having a unit represented by Formula (X2), and the monomer having a unit represented by Formula (X3) are prepared as listed in Table 1 and the temperature of the dropwise addition is changed to 100° C.

### Synthesis of Resins X-E

A resin is obtained in the same manner as in the synthesis of the resin X-A except that the kinds and the amounts of the monomer having a unit represented by Formula (X1), the monomer having a unit represented by Formula (X2), and the monomer having a unit represented by Formula (X3) are prepared as listed in Table 1 and the temperature of the dropwise addition is changed to 80° C.

### Synthesis of Resins X-F

A resin is obtained in the same manner as in the synthesis of the resin X-A except that the kinds and the amounts of the monomer having a unit represented by Formula (X1), the monomer having a unit represented by Formula (X2), and the monomer having a unit represented by Formula (X3) are prepared as listed in Table 1 and the temperature of the dropwise addition is changed to 110° C.

### Synthesis of Resins X-G

A resin is obtained in the same manner as in the synthesis of the resin X-A except that the kinds and the amounts of the monomer having a unit represented by Formula (X1), the monomer having a unit represented by Formula (X2), and the monomer having a unit represented by Formula (X3) are prepared as listed in Table 1 and the temperature of the dropwise addition is changed to 105° C.

### Synthesis of Resins X-H

A resin is obtained in the same manner as in the synthesis of the resin X-A except that the kinds and the amounts of the monomer having a unit represented by Formula (X1), the monomer having a unit represented by Formula (X2), and the monomer having a unit represented by Formula (X3) are prepared as listed in Table 1, the temperature of the dropwise addition is changed to 80° C., and the reaction time is changed to 3 hours.

### Synthesis of Resin X-I

A resin is obtained in the same manner as in the synthesis of the resin X-A except that the kinds and the amounts of the monomer having a unit represented by Formula (X1), the monomer having a unit represented by Formula (X2), and the monomer having a unit represented by Formula (X3) are prepared as listed in Table 1, the temperature of the dropwise addition is changed to 75° C., and the reaction time is changed to 3.5 hours.

### Synthesis of Resin X-J

A resin is obtained in the same manner as in the synthesis of the resin X-A except that the kinds and the amounts of the monomer having a unit represented by Formula (X1), the monomer having a unit represented by Formula (X2), and the monomer having a unit represented by Formula (X3) are prepared as listed in Table 1, the temperature of the dropwise addition is changed to 80° C., and the reaction time is changed to 4 hours.

### Synthesis of Resin X-K

A resin is obtained in the same manner as in the synthesis of the resin X-A except that the kinds and the amounts of the monomer having a unit represented by Formula (X1), the monomer having a unit represented by Formula (X2), and the monomer having a unit represented by Formula (X3) are prepared as listed in Table 1 and the temperature of the dropwise addition is changed to 135° C.

### Synthesis of Resins X-L

A resin is obtained in the same manner as in the synthesis of the resin X-A except that the kinds and the amounts of the monomer having a unit represented by Formula (X1), the monomer having a unit represented by Formula (X2), and the monomer having a unit represented by Formula (X3) are prepared as listed in Table 1.

### Synthesis of Resin X-M

A resin is obtained in the same manner as in the synthesis of the resin X-A except that the kinds and the amounts of the monomer having a unit represented by Formula (X1), the monomer having a unit represented by Formula (X2), and the monomer having a unit represented by Formula (X3) are prepared as listed in Table 1.

### Synthesis of Resin X-N

A resin is obtained in the same manner as in the synthesis of the resin X-A except that the kinds and the amounts of the monomer having a unit represented by Formula (X1), the monomer having a unit represented by Formula (X2), and the monomer having a unit represented by Formula (X3) are prepared as listed in Table 1.

The weight-average molecular weight Mw of each resin acquired by the above-described measuring method is listed in Table 1.

In Table 1, “−” in the columns of each material denote that the material is not contained.

TABLE 1

| | Uait represented | | | Unit represented | | Unit represented | | |
|---|---|---|---|---|---|---|---|---|
| | by Formula | | | by Formula | | by Formula | | |
| | (X1) | | | (X2) | | (X3) | | |
| | (X1-1-12) | (X1-1-24) | (X1-1-29) | (X2-1-13) | (X2-1-6) | (X3-1) | (X3-2) | Mw |
| Resin X-A | — | 2 | — | 10 | — | 3 | — | 8500 |
| Resin X-B | — | 2 | — | 10 | — | 3 | — | 6000 |
| Resin X-C | — | 2 | — | 10 | — | 3 | — | 18000 |
| Resin X-D | — | — | 3 | — | 5 | 4 | — | 12000 |
| Resin X-E | — | 2 | — | — | 6 | 5 | — | 22000 |
| Resin X-F | — | 3 | — | 8 | — | — | 6 | 8000 |
| Resin X-G | — | — | 3 | — | 8 | — | 6 | 10000 |
| Resin X-H | — | 2 | — | — | 8 | — | 6 | 26000 |
| Resin X-I | 3 | — | — | 8 | — | — | — | 38000 |
| Resin X-J | 3 | — | — | — | 6 | — | — | 54000 |
| Resin X-K | — | 2 | — | 10 | — | 3 | — | 800 |
| Resin X-L | 6 | — | 6 | — | — | — | — | 3000 |
| Resin X-M | — | — | — | 8 | 5 | — | — | 7500 |
| Resin X-N | — | — | 4 | — | — | 10 | — | 4000 |

### Production of Photoreceptor Including Lamination Type Photosensitive Layer

### Example 1

An aluminum cylindrical tube having an outer diameter of 30 mm, a length of 250 mm, and a thickness of 1 mm is prepared as a conductive substrate.

### Formation of Undercoat Layer

100 parts of zinc oxide (average particle diameter of 70 nm, specific surface area of 15 m²/g, manufactured by Tayca Corporation) is stirred and mixed with 500 parts of toluene, 1.3 parts of a silane coupling agent (trade name: KBM603, manufactured by Shin-Etsu Chemical Co., Ltd., N-2-(aminoethyl)-3-aminopropyltrimethoxysilane) is added thereto, and the mixture is stirred for 2 hours. Thereafter, toluene is distilled off under reduced pressure and baked at 120° C. for 3 hours to obtain zinc oxide subjected to a surface treatment with a silane coupling agent.

110 parts of the surface-treated zinc oxide is stirred and mixed with 500 parts of tetrahydrofuran, a solution obtained by dissolving 0.6 part of alizarin in 50 parts of tetrahydrofuran is added thereto, and the mixture is stirred at 50° C. for 5 hours. Thereafter, the solid content is separated by filtration by carrying out filtration under reduced pressure and dried at 60° C. under reduced pressure, thereby obtaining zinc oxide with alizarin.

100 parts of a solution obtained by dissolving 60 parts of the zinc oxide with alizarin, 13.5 parts of a curing agent (blocked isocyanate, trade name: SUMIDUR 3175, manufactured by Sumitomo Bayer Urethane Co., Ltd.), and 15 parts of a butyral resin (trade name: S-LEC BM-1, manufactured by Sekisui Chemical Co., Ltd.) in 68 parts of methyl ethyl ketone is mixed with 5 parts of methyl ethyl ketone, and the solution is dispersed in a sand mill for 2 hours using 1 mmφ glass beads, thereby obtaining a dispersion liquid. 0.005 part of dioctyltin dilaurate as a catalyst and 4 parts of silicone resin particles (trade name: TOSPEARL 145, manufactured by Momentive Performance Materials Inc.) are added to the dispersion liquid, thereby obtaining a coating solution for forming an undercoat layer. The outer peripheral surface of the conductive substrate is coated with the coating solution for forming an undercoat layer by a dip coating method, and dried and cured at 170° C. for 40 minutes to form an undercoat layer. The average thickness of the undercoat layer is 25 μm.

### Formation of Charge Generation Layer

A mixture of 15 parts of hydroxygallium phthalocyanine as a charge generation substance (Bragg angle (2θ±0.2°) of the X-ray diffraction spectrum using Cuka characteristic X-ray has diffraction peaks at positions at least of 7.5°, 9.9°, 12.5, 16.3°, 18.6°, 25.1°, and 28.3°), 10 parts of a vinyl chloride-vinyl acetate copolymer resin (trade name: VMCH, Nippon Unicar Company Limited) as a binder resin, and 200 parts of n-butyl acetate is dispersed in a sand mill for 4 hours using glass beads having a diameter of 1 mm. 175 parts of n-butyl acetate and 180 parts of methyl ethyl ketone are added to the dispersion liquid, and the mixture is stirred, thereby obtaining a coating solution for forming a charge generation layer. The undercoat layer is immersed in and coated with the coating solution for forming a charge generation layer, and dried at room temperature (25° C.±3° C.) to form a charge generation layer having an average thickness of 0.18 μm.

### Formation of Charge Transport Layer

55 parts of a polycarbonate Z resin having a viscosity average molecular weight of 50,000 and 40 parts of a charge transport material CTM-1 are dissolved in 270 parts of tetrahydrofuran and 30 parts of toluene, thereby obtaining a coating solution for forming a charge transport layer. The charge generation layer is immersed in and coated with the coating solution for forming a charge transport layer, and dried at 115° C. for 50 minutes to form a charge transport layer. The average film thickness of the charge transport layer is 24 μm.

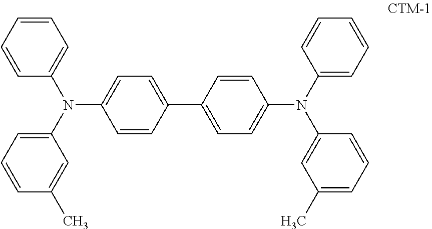 [SMILES: Cc1cccc(N(c2ccccc2)c2ccc(-c3ccc(N(c4ccccc4)c4cccc(C)c4)cc3)cc2)c1]

### Formation of Surface Protective Layer

10 parts by mass of a charge transport material (I-25), 10 parts by mass of a charge transport material (I-8), 2 parts by mass of a charge transport material (I-26), 1 part by mass of a charge transport material (I-27), and 0.5 parts by mass of methoxymethylated melamine ((B)-2) are added to a mixed solvent of 30 parts by mass of isopropanol and 15 parts by mass of n-butanol and stirred and dissolved at 50° C. for 2 hours. Next, the mixed solution is allowed to be naturally cooled to room temperature (25° C.), 0.1 parts by mass of a curing catalyst Nacure5925 (manufactured by King Industries, Inc.) and 0.08 parts by mass of the resin X-A are added to the solution, thereby obtaining a coating solution for forming a surface protective layer.

The charge transport layer is immersed in and coated with the coating solution for forming a surface protective layer, touch-dried at 25° C. for 10 minutes, and dried and cured at 150° C. for 40 minutes, thereby obtaining a photoreceptor of Example 1.

### Examples 2 to 15

Each photoreceptor of the examples is prepared in the same manner as in Example 1 except that a resin of the kind with the mass proportion listed in Table 1 is used in the step of forming the surface protective layer.

### Example 16

A photoreceptor of the example 16 is prepared in the same manner as in Example 1 except that a guanamine compound ((A)-14) is used in place of 0.5 parts by mass of the methoxymethylated melamine ((B)-2) which is a melamine compound in the step of forming the surface protective layer.

### Comparative Examples 1 and 2

Each photoreceptor of the examples is prepared in the same manner as in Example 1 except that a resin of the kind with the mass proportion listed in Table 1 is used in place of the resin (X) in the step of forming the surface protective layer.

In Table 1, Mw denotes the weight-average molecular weight of the resin (X) or the comparative resin acquired by the above-described measuring method.

In Table 2, “mass proportion (% by mass) of resin” denotes the mass proportion of the resin (X) in the mass of the surface protective layer. Here, in the comparative example in which KP-340 or KP-104 is used in place of the resin (X), “mass proportion (% by mass) of resin” is calculated by regarding KP-340 or KP-104 as the resin (X).

### Evaluation

### Evaluation of Surface of Coating Film of Surface Protective Layer

After the surface of each photoreceptor (that is, the surface of the surface protective layer) of the examples in the step of forming the surface protective layer is touch-dried at 25° C. for 30 minutes, the surface of the photoreceptor is observed visually and with an optical microscope, and the surface unevenness and concave defects are evaluated according to the following standards. The results are listed as “evaluation of coating film” in Table 2.

A: Surface unevenness and local concave defects are not found, which is not problematic.

B: Surface unevenness has slightly occurred in a part of the region at an acceptable level in practical use.

C: Surface unevenness has clearly occurred in a part of the region at an acceptable level in practical use.

D: Surface unevenness and concaves have clearly occurred at an unacceptable level in practical use.

### Evaluation of Surface of Cured Film

After the surface of each photoreceptor (that is, the surface of the surface protective layer) of the examples is dried and cured at 150° C. for 40 minutes, the surface of the photoreceptor is observed visually and with an optical microscope, and the surface unevenness and coating film defects are evaluated according to the following standards. The results are listed as “evaluation of cured film” in Table 2.

A: Surface unevenness and local unevenness are not found, which is not problematic.

B: Surface unevenness has slightly occurred in a part of the region at an acceptable level in practical use.

C: Surface unevenness has clearly occurred in a part of the region at an acceptable level in practical use.

D: Surface unevenness and concaves and protrusions have clearly occurred at an unacceptable level in practical use.

### Evaluation of Streak-like Image Defect

The photoreceptor of each example is attached to an image forming apparatus Color 1000i Press (manufactured by FUJIFILM Business Innovation Corporation), a chart image having an image density (area coverage) of 10% is continuously output onto 50,000 sheets of A4 size plain paper in an environment of a temperature of 30° C. and a relative humidity of 85% (high-temperature and high-humidity environment), the 10th image and the 50,000th image are visually observed, and the streak-like image defects are classified into the following items A to E.

A: Streak-like image defects are not found and the image quality is not problematic.

B: Streak-like image defects are slightly found in a part of the image at an acceptable level in practical use.

C: Streak-like image defects are clearly found in a part of the image at an acceptable level in practical use.

D: Streak-like image defects are found in more than half of the image at a level that the defects cannot be ignored in terms of the image quality.

E: Streak-like image defects are found in the entire image at an unacceptable level in practical use.

TABLE 2

| | | | | Evaluation | | |
|---|---|---|---|---|---|---|
| | | | | | | Evaluation |
| | | | Mass | Evaluation | Evaluation | of |
| | Surface protective layer | | proportion | of surface | of surface | streak-like |
| | Resin | | of resin | of coating | of cured | image |
| | Type | Configuration | (% by mass) | film | film | defects |
| Example 1 | Resin X-A | Copolymerization graft type | 0.5 | A | A | A |
| Example 2 | Resin X-B | Copolymerization graft type | 1.2 | A | A | A |
| Example 3 | Resin X-C | Copolymerization graft type | 0.4 | A | A | A |
| Example 4 | Resin X-D | Copolymerization graft type | 0.5 | A | A | A |
| Example 5 | Resin X-E | Copolymerization graft type | 0.5 | A | A | B |
| Example 6 | Resin X-F | Copolymerization graft type | 0.5 | A | A | A |
| Example 7 | Resin X-G | Copolymerization graft type | 0.5 | A | A | A |
| Example 8 | Resin X-H | Copolymerization graft type | 0.5 | A | A | B |
| Example 9 | Resin X-I | Copolymerization graft type | 0.5 | B | B | B |
| Example 10 | Resin X-J | Copolymerization graft type | 0.5 | B | B | C |
| Example 11 | Resin X-K | Copolymerization graft type | 0.5 | C | C | C |
| Example 12 | Resin X-L | Copolymerization graft type | 0.5 | A | B | B |
| Example 13 | Resin X-M | Copolymerization graft type | 0.5 | B | B | B |
| Example 14 | Resin X-N | Copolymerization graft type | 0.5 | A | B | B |
| Example 15 | Resin X-A | Copolymerization graft type | 0.25 | A | A | A |
| Example 16 | Resin X-A | Copolymerization graft type | 0.5 | A | A | A |
| Comparative | KP-340 | Straight type | 0.5 | D | D | E |
| Example 1 | (manufactured by | | | | | |
| | Shin-Etsu Chemical | | | | | |
| | Co., Ltd.) | | | | | |
| Comparative | KP-104 | Straight type | 0.5 | C | D | D |
| Example 2 | (manufactured by | | | | | |
| | Shin-Etsu Chemical | | | | | |
| | Co., Ltd.) | | | | | |

As listed in each table, it has been found that the photoreceptors of the examples reduce streak-like image defects caused by coating film defects that occur in the process of producing the surface protective layer, as compared with the photoreceptors of the comparative examples.

(((1))) An electrophotographic photoreceptor comprising:

a conductive substrate;

a charge generation layer provided on the conductive substrate;

a charge transport layer provided on the charge generation layer; and

a surface protective layer provided on the charge transport layer,

wherein the surface protective layer is a cured film formed of a composition that contains a resin (X) having at least one of a unit represented by Formula (X1) or a unit represented by Formula (X2) and a reactive group-containing charge transport material containing a reactive group and a charge-transporting skeleton in an identical molecule,

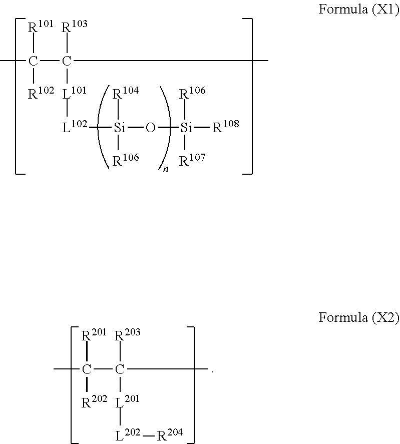

in Formula (X1), R¹⁰¹, R¹⁰², and R¹⁰³ each independently represent a hydrogen atom or an alkyl group having 1 or more and 5 or less carbon atoms, L¹⁰¹ represents a single bond, an alkylene group having 1 or more and 5 or less carbon atoms, —O—, —C(═O)—, —C(═O)O—, an aromatic ring that may have a substituent, or a combination thereof, L¹⁰² represents a single bond, an alkylene group having 1 or more and 5 or less carbon atoms, —O—, —C(═O)—, —C(═O)O—, or a combination thereof, R¹⁰⁴ and R¹⁰⁵ each independently represent an alkyl group having 1 or more and 5 or less carbon atoms, n represents an integer of 0 or greater and 300 or less, R¹⁰⁶, R¹⁰⁷, and R¹⁰⁸ each independently represent an alkyl group having 1 or more and 5 or less carbon atoms or —O—[Si(R¹⁰⁹)(R¹¹⁰)O]ₘ—Si(R¹¹¹)(R¹¹²)(R¹¹³), R¹⁰⁹, R¹¹⁰, R¹¹¹, R¹¹², and R¹¹³ each independently represent an alkyl group having 1 or more and 5 or less carbon atoms, and m represents an integer of 0 or greater and 20 or less,

in Formula (X2), R²⁰¹, R²⁰², and R²⁰³ each independently represent a hydrogen atom or an alkyl group having 1 or more and 5 or less carbon atoms, L²⁰¹ represents a single bond, an alkylene group having 1 or more and 5 or less carbon atoms, —O—, —C(═O)—, —C(═O)O—, an aromatic ring that may have a substituent, or a combination thereof, L²⁰² represents a single bond, an alkylene group having 1 or more and 5 or less carbon atoms, —O—, —C(═O)—, —C(═O)O—, or a combination thereof, and R²⁰⁴ is an alkyl group having 6 or more and 30 or less carbon atoms.

(((2))) The electrophotographic photoreceptor according to (((1))),

wherein the composition contains a curing agent, and

the curing agnet contains at least one compound selected from a guanamine compound or a melamine compound.

(((3))) The electrophotographic photoreceptor according to (((1))) or (((2))),

wherein the resin (X) has a weight-average molecular weight of 1,000 or greater and 30,000 or less.

(((4))) The electrophotographic photoreceptor according to (((3))),

wherein the resin (X) has a weight-average molecular weight of 1,000 or greater and 10,000 or less.

(((5))) The electrophotographic photoreceptor according to any one of (((1))) to (((4))),

wherein the resin (X) has both the unit represented by Formula (X1) and the unit represented by Formula (X2).

(((6))) The electrophotographic photoreceptor according to (((5))), wherein the resin (X) further has a unit represented by Formula (X3),

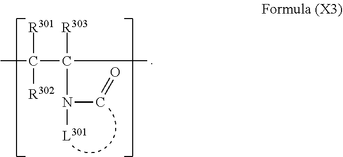

in Formula (X3), R³⁰¹, R³⁰², and R³⁰³ each independently represent a hydrogen atom or an alkyl group having 1 or more and 5 or less carbon atoms, and L³⁰¹ represents an alkylene group having 3 or more and 10 or less carbon atoms.

(((7))) The electrophotographic photoreceptor according to any one of (((1))) to (((6))),

wherein a mass proportion of the resin (X) in the surface protective layer is 0.01% by mass or greater and 0.30% by mass or less.

(((8))) A process cartridge comprising:

the electrophotographic photoreceptor according to any one of (((1))) to (((7))),

wherein the process cartridge is attachable to and detachable from an image forming apparatus.

(((9))) An image forming apparatus comprising:

the electrophotographic photoreceptor according to any one of (((1))) to (((7)));

a charging device that charges a surface of the electrophotographic photoreceptor;

an electrostatic latent image forming device that forms an electrostatic latent image on the charged surface of the electrophotographic photoreceptor;

a developing device that develops the electrostatic latent image formed on the surface of the electrophotographic photoreceptor with a developer containing a toner to form a toner image; and

a transfer device that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate;
a charge generation layer provided on the conductive substrate;
a charge transport layer provided on the charge generation layer; and
a surface protective layer provided on the charge transport layer,
wherein the surface protective layer is a cured film formed of a composition that contains a resin (X) having at least one of a unit represented by Formula (X1) or a unit represented by Formula (X2) and a reactive group-containing charge transport material containing a reactive group and a charge-transporting skeleton in an identical molecule, 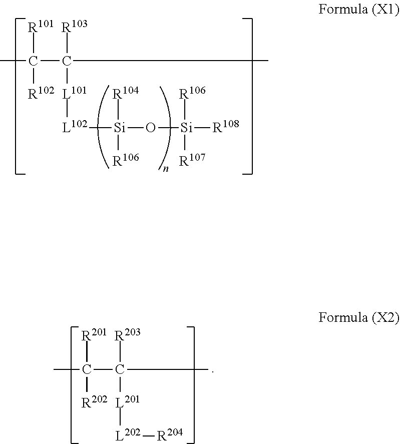
in Formula (X1), R¹⁰¹, R¹⁰², and R¹⁰³ each independently represent a hydrogen atom or an alkyl group having 1 or more and 5 or less carbon atoms, L¹⁰¹ represents a single bond, an alkylene group having 1 or more and 5 or less carbon atoms, —O—, —C(═O)—, —C(═O)O—, an aromatic ring that may have a substituent, or a combination thereof, L¹⁰² represents a single bond, an alkylene group having 1 or more and 5 or less carbon atoms, —O—, —C(═O)—, —C(═O)O—, or a combination thereof, R¹⁰⁴ and R¹⁰⁵ each independently represent an alkyl group having 1 or more and 5 or less carbon atoms, n represents an integer of 0 or greater and 300 or less, R¹⁰⁶, R¹⁰⁷, and R¹⁰⁸ each independently represent an alkyl group having 1 or more and 5 or less carbon atoms or —O—[Si(R¹⁰⁹)(R¹¹⁰)O]ₘ-Si(R¹¹¹)(R¹¹²)(R¹¹³), R¹⁰⁹, R¹¹⁰, R¹¹¹, R¹¹², and R¹¹³ each independently represent an alkyl group having 1 or more and 5 or less carbon atoms, and m represents an integer of 0 or greater and 20 or less,
in Formula (X2), R²⁰¹, R²⁰², and R²⁰³ each independently represent a hydrogen atom or an alkyl group having 1 or more and 5 or less carbon atoms, L²⁰¹ represents a single bond, an alkylene group having 1 or more and 5 or less carbon atoms, —O—, —C(═O)—, —C(═O)O—, an aromatic ring that may have a substituent, or a combination thereof, L²⁰² represents a single bond, an alkylene group having 1 or more and 5 or less carbon atoms, —O—, —C(═O)—, —C(═O)O—, or a combination thereof, and R²⁰⁴ is an alkyl group having 6 or more and 30 or less carbon atoms.

2. The electrophotographic photoreceptor according to claim 1,
wherein the composition contains a curing agent, and
the curing agent contains at least one compound selected from a guanamine compound or a melamine compound.

3. The electrophotographic photoreceptor according to claim 1,
wherein the resin (X) has a weight-average molecular weight of 1,000 or greater and 30,000 or less.

4. The electrophotographic photoreceptor according to claim 3,
wherein the resin (X) has a weight-average molecular weight of 1,000 or greater and 10,000 or less.

5. The electrophotographic photoreceptor according to claim 1,
wherein the resin (X) has both the unit represented by Formula (X1) and the unit represented by Formula (X2).

6. The electrophotographic photoreceptor according to claim 5,
wherein the resin (X) further has a unit represented by Formula (X3), 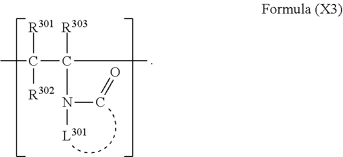
in Formula (X3), R³⁰¹, R³⁰², and R³⁰³ each independently represent a hydrogen atom or an alkyl group having 1 or more and 5 or less carbon atoms, and L³⁰¹ represents an alkylene group having 3 or more and 10 or less carbon atoms.

7. The electrophotographic photoreceptor according to claim 1,
wherein a mass proportion of the resin (X) in the surface protective layer is 0.01% by mass or greater and 0.30% by mass or less.

8. A process cartridge comprising:
the electrophotographic photoreceptor according to claim 1,
wherein the process cartridge is attachable to and detachable from an image forming apparatus.

9. A process cartridge comprising:
the electrophotographic photoreceptor according to claim 2,
wherein the process cartridge is attachable to and detachable from an image forming apparatus.

10. A process cartridge comprising:
the electrophotographic photoreceptor according to claim 3,
wherein the process cartridge is attachable to and detachable from an image forming apparatus.

11. A process cartridge comprising:
the electrophotographic photoreceptor according to claim 4,
wherein the process cartridge is attachable to and detachable from an image forming apparatus.

12. A process cartridge comprising:
the electrophotographic photoreceptor according to claim 5,
wherein the process cartridge is attachable to and detachable from an image forming apparatus.

13. A process cartridge comprising:
the electrophotographic photoreceptor according to claim 6,
wherein the process cartridge is attachable to and detachable from an image forming apparatus.

14. A process cartridge comprising:
the electrophotographic photoreceptor according to claim 7,
wherein the process cartridge is attachable to and detachable from an image forming apparatus.

15. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

16. An image forming apparatus comprising:
the electrophotographic photoreceptor according to claim 2;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

17. An image forming apparatus comprising:
the electrophotographic photoreceptor according to claim 3;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

18. An image forming apparatus comprising:
the electrophotographic photoreceptor according to claim 4;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

19. An image forming apparatus comprising:
the electrophotographic photoreceptor according to claim 5;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

20. An image forming apparatus comprising:
the electrophotographic photoreceptor according to claim 6;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.
